(19) United States
(12) Patent Application Publication
(10) Pub. No.: US 2026/0105357 A1
(43) Pub. Date: Apr. 16, 2026

(54) SYSTEM AND METHOD FOR CONTEXTUAL DISCOVERY AND PRIORITIZATION OF HARDWARE PROCESSORS FOR EXECUTION OF ARTIFICIAL INTELLIGENCE TOOL MACHINE LEARNING MODEL ALGORITHMS ON AN INFORMATION HANDLING SYSTEM

(71) Applicant: Dell Products LP, Round Rock, TX (US)

(72) Inventors: Daniel L. Hamlin, Round Rock, TX (US); Srikanth Kondapi, Austin, TX (US); Balasingh Ponraj Samuel, Round Rock, TX (US)

(73) Assignee: Dell Products LP, Round Rock, TX (US)

(21) Appl. No.: 18/916,414

(22) Filed: Oct. 15, 2024

(51) Int. Cl. G06N 20/00

(52) U.S. Cl. CPC G06N 20/00

(57) ABSTRACT

An information handling system includes a hardware processor with the hardware processor executing an AI productivity tool software module to invoke a plurality of ML model algorithms to identify a responsive capability intent action based on received user-query input, a system environment component discovery software application to gather runtime telemetry data describing a current consumption state of a plurality of available in-band, side-band, and networked ML model algorithm execution provider hardware processors, and a workload orchestrator to receive the runtime telemetry data and determine when the workload orchestrator switches from a first ML model algorithm execution provider hardware processor used to execute at least one of the plurality of ML model algorithms to a second ML model algorithm execution provider hardware processor having less active processing and that is capable. Further, the workload orchestrator may determine when to switch size-variants of an ML model algorithm based on output confidence scores.

### FIELD OF THE DISCLOSURE

The present disclosure generally relates to execution of computer-readable program code instructions of an AI productivity tool software module with one or more machine learning (ML) model algorithms to identify a capability associated with the execution of an artificial intelligence (AI) productivity tool-enablable software application responsive to user-query inputs. The present disclosure more specifically relates systems and methods of executing computer-readable program code instructions of a system environment component discovery software to identify available ML model algorithm execution provider hardware processors to execute one or more ML model algorithms to identify a capability associated with the execution of an AI productivity tool-enablable software application responsive to user-query inputs.

### BACKGROUND

As the value and use of information continues to increase, individuals and businesses seek additional ways to process and store information. One option available to clients is information handling systems. An information handling system generally processes, compiles, stores, and/or communicates information or data for business, personal, or other purposes thereby allowing clients to take advantage of the value of the information. Because technology and information handling may vary between different clients or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific client or specific use, such as e-commerce, financial transaction processing, airline reservations, enterprise data storage, or global communications. In addition, information handling systems may include a variety of hardware and software components that may be configured to process, store, and communicate information and may include one or more computer systems, data storage systems, and networking systems. The information handling system may include telecommunication, network communication, and video communication capabilities. The information handling system may be used to execute instructions for one or more workplace productivity applications or other application such as for teleconferencing, word processing, sales systems, business software, gaming applications, or the like. Further, the information handling system may include an on the box (OTB) artificial intelligence (AI) productivity tool software module employing machine learning (ML) models stored locally at the information handling system, as installed by a manufacturer of the information handling system, for optimizing user productivity and information handling system performance.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system that includes computer-readable program code instructions for selection among operatively coupled available ML model algorithm execution provider hardware processors for execution of an AI productivity tool software module to determine AI productivity tool-enablable software applications having responsive capabilities to a user query input and according to an embodiment of the present disclosure;

FIG. 2 is a graphic and block diagram illustrating an information handling system that includes computer-readable program code instructions for selecting among operatively coupled available ML model algorithm execution provider hardware processor used to execute an AI productivity tool software module to determine AI productivity tool-enablable software applications having responsive capabilities to user query inputs according to another embodiment of the present disclosure;

FIG. 3 is a flow diagram showing a method of executing computer-readable program code instructions for discovering and prioritizing available ML model algorithm execution provider hardware processors based on identified ML model algorithms to be invoked to identify and execute a capability intent action at an information handling system responsive to a user query input according to an embodiment of the present disclosure; and

FIG. 4 is a flow diagram showing a method of executing computer-readable program code instructions for detecting a user-query input and selecting variable-sized ML model algorithms and among available ML model algorithm execution provider hardware processors based on identified ML model algorithm to be invoked to identify and execute a responsive capability intent action at an information handling system according to another embodiment of the present disclosure.

The use of the same reference symbols in different drawings may indicate similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

Information handling systems, including computers, mobile computers, and smart phones are increasingly employing artificial intelligence (AI) productivity tool software applications to optimize user productivity and performance of the information handling systems. Examples of such artificial intelligence methodologies include chatbots to simulate conversations between the information handling system and the user. In an example embodiment of the present disclosure, an AI productivity tool software module may be used to trigger changes in firmware or hardware (e.g., changing display or power settings), software, or processes of one or more AI productivity tool-enablable software applications (e.g., send an e-mail or text message, schedule a meeting) responsive to a user query input. Various machine learning models may be used to support such functionality, including automatic speech recognition (ASR) models, text embedding models, and semantic or lexical similarity search models that may work in combination with one another to identify a capability intent action that may be taken by an AI productivity tool-enablable software applications as requested within a received user-query input according to embodiments herein. For example, an AI productivity tool software module and an operatively-coupled AI productivity tool subagent may be capable of determining a user's intent from a user query input for correlation to a capability intent action that is responsive to a user-query input. The AI productivity tool software module and AI productivity tool subagent matches a determined query intent, embedded from the user query input, with a capability intent known to be achievable, based on published or established capabilities by a particular of one or more AI productivity tool-enablable software applications executing at the information handling system. In some examples, once the AI productivity tool-enablable software application capable of performing the user-requested capability intent action within the user-query input is identified, the AI productivity tool subagent may identify an application programming interface (API) call that, when executed, may cause the AI productivity tool-enablable software application associated with the identified capability to perform that identified, responsive capability intent action.

As described herein, however, the AI productivity tool subagent identifies one or more capabilities of the AI productivity tool-enablable software application or applications that can provide the responsive capability intent action or actions identified from the user-query input by invoking execution of computer readable code instructions of one or more ML model algorithms in order to identify the query intent value, similarity match the query intent value or the user query input with a capability intent value or natural language description of a capability to identify an appropriate AI productivity tool-enablable software application that can perform the responsive capability intent action. These ML model algorithms may consume a significant amount of system resources from a hardware processor or other ML model algorithm execution provider hardware processor, for example, and may also impact performance at the information handling system, especially when multiple ML model algorithms are being executed or the information handling system has many other ongoing software processes. This is despite instances where the hardware processor devices may be specialized hardware processing devices such as a neural processing unit (NPU) that is designed to accelerate the execution of computer-readable program code instructions of artificial intelligence (AI) and machine learning (ML) applications. Executing this computer-readable program code instructions of the AI productivity tool software module and ML model algorithm applications described herein may consume significant processing resources in the information handling system even where the specially designed hardware processing devices (e.g., NPU) are available on-the-box.

The present specification describes systems and methods of discovering and prioritizing available ML model algorithm execution provider hardware processors in an information handling system. This system and method may include executing, with a hardware processor, computer-readable program code instructions of an AI productivity tool software module to invoke a plurality of ML model algorithms via an AI productivity tool subagent to identify a responsive capability intent action based on user query input received at the AI productivity tool software module. Concurrently, the system and method may also include executing, with the hardware processor, computer-readable program code instructions of a system environment component discovery software application to gather runtime telemetry data describing a current consumption state of a plurality of in-band, side-band, and networked ML model algorithm execution provider hardware processors within or operatively coupled to the information handling system as the invoked plurality of ML model algorithms are being executed by one or more of the plurality of ML model algorithm execution provider hardware processors.

In an embodiment, the “in-band” ML model algorithm execution provider hardware processors may include those hardware processing devices that are “on-the-box” and found as hardware within the information handling system. In an embodiment, the “side-band” ML model algorithm execution provider hardware processors may be hardware processing devices that are accessible to the information handling system over, for example, a personal area network (PAN) that may include wireless communication, such as by Bluetooth® (BT), or wired communication between the information handling system and other information handling systems or smart devices such as a smartphone, a tablet, a personal digital assistant, and docking station among others. In an embodiment, the “networked” ML model algorithm execution provider hardware processors may include those ML model algorithm execution provider hardware processors that are made accessible to the information handling system via a wired or wireless connection to a network such as the internet, for example, via a large area network (LAN), wireless LAN (WLAN), wide area network (WAN), or wireless WAN (WWAN). The networked ML model algorithm execution provider hardware processors in such an operatively-coupled network may be included edge network information handling systems in that network in embodiments herein.

In an embodiment, the systems and methods described herein may include executing, with the hardware processor, computer-readable program code instructions of the AI productivity tool software module to invoke a first size-variant ML model algorithm selected from a plurality of available size-variant ML model algorithms that may be executed to perform a step or operation for an AI productivity tool software module to identify the responsive capability intent action based on the user query input received at the AI productivity tool software module. The plurality of available size-variant ML model algorithms includes disparate number of input parameters accepted as well as processing bit sizes determining the size of each of the plurality of available size-variant ML model algorithms in example embodiment. Several operation steps of the AI productivity tool software module to identify and execute responsive capability intent actions may utilize a type of ML model algorithm, where any or each of which may have a plurality of available size-variant ML model algorithm options that have tradeoffs between output accuracy and processor execution consumption levels during execution. In an embodiment, therefore, the invocation of a selected ML model algorithm execution provider hardware processor to execute any available size-variant ML model algorithms may be dictated by the gathered runtime telemetry data described herein, but also be selected so that a quality of service (QoS) metric threshold for execution of the ML model algorithm by operations of an AI productivity tool software module is maintained or met. In an embodiment, the hardware processor may also execute the computer readable program code of the workload orchestrator to determine a ML model algorithm confidence score associated with the execution of any of the size-variant ML model algorithms such that, when the ML model algorithm confidence score does not meet a threshold ML model algorithm confidence score that the output will provide an acceptable level of accuracy, the workload orchestrator switches to a different size-variant ML model algorithm.

In the context of the present specification, the ML model algorithm execution provider hardware processing resource may be one or a combination of operatively coupled or onboard ML model algorithm execution provider hardware processing resources such as a central processing unit (CPU), an embedded controller (EC), a graphics processing unit (GPU), a neural processing unit (NPU), and an audio processing unit (APU), or the like. Some of these hardware processing devices may not be included “on-the-box” of the information handling system in some embodiments. The execution of the computer-readable program code of the system environment component discovery software application may identify the availability of these hardware devices or, in the context of embodiments of the present specification, any and all ML model algorithm execution provider hardware processors that are available as on-the-box or operatively coupled via side-band communication or network communications. The runtime telemetry data may be obtained while the one ML model algorithm execution provider (e.g., a hardware processor) is executing computer-readable program code of an ML model algorithm performing an operational step of the AI productivity tool software module used to identify the capability intent action associated with one or more AI productivity tool-enablable software applications responsive to a received user-query input.

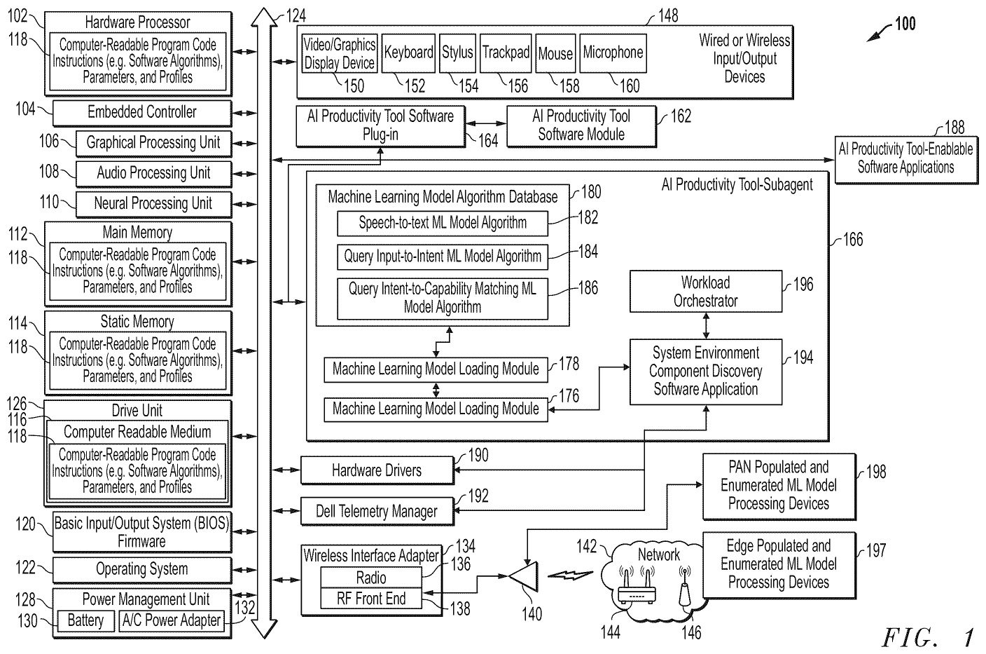

Turning now to the figures, FIG. 1 illustrates an information handling system 100 similar to the information handling systems according to several aspects of the present disclosure. In the embodiments described herein, an information handling system 100 includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system 100 may be a personal computer, mobile device (e.g., personal digital assistant (PDA) or smart phone), server (e.g., blade server or rack server), a consumer electronic device, a network server or storage device, a network router, switch, or bridge, wireless router, or other network communication device, a network connected device (cellular telephone, tablet device, etc.), IoT computing device, wearable computing device, a set-top box (STB), a mobile information handling system, a palmtop computer, a laptop computer, a desktop computer, a communications device, an access point (AP) 144, a base station transceiver 146, a wireless telephone, a control system, a camera, a scanner, a printer, a personal trusted device, a web appliance, or any other suitable machine capable of executing a set of instructions (sequential or otherwise) that specify capability intent actions to be taken by that machine, and may vary in size, shape, performance, price, and functionality.

In a networked deployment, the information handling system 100 may operate in the capacity of a client computer in a server-client network environment, or as a peer computer system in a peer-to-peer (or distributed) network environment. In an embodiment, the information handling system 100 may be implemented using electronic devices that provide voice, video, or data communication. For example, an information handling system 100 may be any mobile or other computing device capable of executing a set of instructions (sequential or otherwise) that specify actions to be taken by that machine. Further, while a single information handling system 100 is illustrated, the term “system” shall also be taken to include any collection of systems or sub-systems that individually or jointly execute a set, or plural sets, of instructions to perform one or more computer functions.

The information handling system 100 may include main memory 112, (volatile (e.g., random-access memory, etc.), or static memory 114, nonvolatile (read-only memory, flash memory etc.) or any combination thereof), one or more hardware processing resources, such as a hardware processor 102 (e.g., central processing unit (CPU)), an embedded controller (EC) 104, a graphics processing unit (GPU) 106, a neural processing unit (NPU) 110, an accelerated processing unit (NPU) 108, other types of hardware processing devices, or any combination thereof. It is appreciated that the information handling system 100 may include any number of hardware processing devices described herein. These hardware processing devices on the box of the information handling system 100 may be referred to herein as in-band machine learning (ML) model algorithm execution provider hardware processors and are candidates to execute computer readable code instructions of ML model algorithms for executing operational steps by the AI productivity tool software module 162 in embodiments herein. In other embodiments herein, some hardware processing devices may be accessible from operatively coupled devices to information handling system 100 such as edge populated and enumerated ML model processing devices as networked ML model algorithm execution provider hardware processors 197. In yet other embodiments herein, some hardware processing devices may be accessible from operatively coupled devices to information handling system 100 such as PAN populated and enumerated ML model processing devices as side-band ML model algorithm execution provider hardware processors 198.

Computer readable code instructions stored in main memory 112 (e.g., RAM) may be quickly accessible by hardware processing resources using that main memory 112. Computer-readable program code instructions stored in static memory 114, main memory 112, or drive unit 126 may involve some latency in invoking such computer-readable program code instructions to main memory 112 according to embodiments herein. Additional components of the information handling system 100 may include one or more storage devices such as static memory 114 or drive unit 126. The information handling system 100 may include or interface with one or more communications ports for communicating with external devices, as well as various input and output (I/O) devices 148, such as a mouse 158, a trackpad 156, a stylus 154, a keyboard 152, a video/graphics display device 150, a microphone 160, or any combination thereof. Portions of an information handling system 100 may themselves be considered information handling systems 100.

Information handling system 100 may include devices or modules that embody one or more of the devices or execute instructions for one or more systems and modules. The information handling system 100 may execute computer-readable program code instructions (e.g., software algorithms) parameters, and profiles 118 that may operate on servers or systems, remote data centers, or on-box in individual client information handling systems according to various embodiments herein. In some embodiments, it is understood any or all portions of computer-readable program code instructions (e.g., software algorithms) parameters, and profiles 118 may operate on a plurality of information handling systems 100.

The information handling system 100 may include the hardware processor 102 such as a central processing unit (CPU) or other hardware processing resources. Any of the hardware processing resources may operate to execute code that is either firmware or software code. Moreover, the information handling system 100 may include memory such as main memory 112, static memory 114, and disk drive unit 126 (volatile (e.g., random-access memory, etc.), nonvolatile memory (read-only memory, flash memory etc.) or any combination thereof or other memory with computer readable medium 116 storing computer-readable program code instructions (e.g., software algorithms) parameters, and profiles 118 executable by the hardware processor 102 (e.g., central processing unit), NPU 110, APU 108, EC 104, GPU 106, or any other hardware processing device. The information handling system 100 may also include one or more buses 124 operable to transmit communications between the various hardware components such as any combination of various I/O devices 148 as well as between hardware processors 102, an EC 104, the operating system (OS) 122, the basic input/output system (BIOS) 120, the wireless interface adapter 134, or a radio module, among other components described herein. In an embodiment, the hardware processor 102, EC 104, GPU 106, NPU 110, APU 108, and/or others may execute one or more bus drivers in order to transmit this data between the information handling system 100 and the input/output devices 148 described herein. In an embodiment, the information handling system 100 may be in wired or wireless communication with the I/O devices 148 such as a keyboard 152, a mouse 158, video/graphics display device 150, stylus 154, trackpad 156, microphone 160, among other peripheral devices.

As described herein, the information handling system 100 further includes a video/graphics display device 150. The video/graphics display device 150 in an embodiment may function as a liquid crystal display (LCD), an organic light emitting diode (OLED), a flat panel display, or a solid-state display. It is appreciated that the video/graphics display device 150 may be wired or wireless and may be an external video/graphics display device 150 that allows a user to increase the desktop area by extending the desktop in an embodiment. Additionally, as described herein, the information handling system 100 may include or be operatively coupled to a cursor control device (e.g., a trackpad 156, or gesture or touch screen input), a stylus 154, and/or a keyboard 152, among others that allows the user to interface with the information handling system 100 via the video/graphics display device 150. Information handling system 100 may also be operatively coupled to a wired or wireless input/output device 148 or other hardware devices that may include a hardware processing device such as a hardware processor, microcontroller, or other hardware processing resource. Various drivers and hardware control device electronics may be operatively coupled to operate the I/O devices 148 according to the embodiments described herein. The present specification contemplates that the I/O devices 148 may be wired or wireless.

A network interface device of the information handling system 100 may be wired or wireless such as shown with wireless interface adapter 134 that can provide wireless connectivity among devices such as with Bluetooth® or to a network 142, e.g., a wide area network (WAN), a local area network (LAN), wireless local area network (WLAN), a wireless personal area network (WPAN), a wireless wide area network (WWAN), a personal area network (PAN) or other network. In embodiments described herein, the wireless interface device 134 with its radio 136, RF front end 138 and antenna 140 is used to communicate with the wireless peripheral devices, via, for example, a Bluetooth® or Bluetooth® Low Energy (BLE) protocols or any proprietary RF protocol such as those may utilize similar frequency ranges but proprietary modulation and data transmission characteristics. In embodiments, Bluetooth®, BLE, proprietary RF protocol, or other WPAN or WLAN protocols and plural such protocols may be used for communication with and among any wireless peripheral device to be paired or paired with the information handling system 100 or other information handling systems.

In other embodiments, a WAN, WWAN, LAN, and WLAN may each include an AP 144 or base station 146 used to operatively couple the information handling system 100 to a network 142 via a wireless interface adapter 134. In a specific embodiment, the network 142 may include macro-cellular connections via one or more base stations 142 or a wireless AP 144 (e.g., Wi-Fi), or such as through licensed or unlicensed WWAN small cell base stations 146. Connectivity may be via wired or wireless connection. For example, wireless network wireless APs 144 or base stations 146 may be operatively connected to the information handling system 100. Wireless interface adapter 134 may include one or more RF (RF) subsystems (e.g., radio 136) with transmitter/receiver circuitry, modem circuitry, one or more antenna RF (RF) front end circuits 138, one or more wireless controller circuits, amplifiers, antennas 140 and other circuitry of the radio 136 such as one or more antenna ports used for wireless communications via multiple radio access technologies (RATs). The radio 136 may communicate with one or more wireless technology protocols.

In an embodiment, the wireless interface adapter 134 may operate in accordance with any wireless data communication standards. To communicate with a wireless local area network, standards including IEEE 802.11 WLAN standards (e.g., IEEE 802.11ax-2021 (Wi-Fi 6E, 6 GHZ)), IEEE 802.15 WPAN standards, WWAN such as 3GPP or 3GPP2, Bluetooth® standards, proprietary RF protocol, or similar wireless standards may be used. Wireless interface adapter 134 may connect to any combination of macro-cellular wireless connections including 2G, 2.5G, 3G, 4G, 5G or the like from one or more service providers. Utilization of RF communication bands according to several example embodiments of the present disclosure may include bands used with the WLAN standards and WWAN carriers which may operate in both licensed and unlicensed spectrums. The wireless interface adapter 134 can represent an add-in card, wireless network interface module that is integrated with a main board of the information handling system 100 or integrated with another wireless network interface capability, or any combination thereof. It is appreciated that, along with the wireless interface adapter 134, the information handling system 100 may also include a wired interface adapter (not shown). The wired interface adapter may also be operatively coupled to one or both of the AP 144 and the base station transceiver 146 via a wired connection to gain access to the network 142. The connection to the network 142 via the wireless interface adapter 134 and wired interface adapter may provide for parallel connectivity to the network 142 in some embodiments.

In some embodiments, a hardware processing resource executes computer-readable program code instructions of software or firmware to implement one or more of some systems and methods described herein, or dedicated hardware implementations such as application specific integrated circuits, programmable logic arrays and other hardware devices may be constructed to implement one or more of some systems and methods described herein. Applications that may include the apparatus and systems of various embodiments may broadly include a variety of electronic and computer systems. One or more embodiments described herein may implement functions using two or more specific interconnected hardware devices with related control and data signals that may be communicated between and through the modules, or as portions of an application-specific integrated circuit. Accordingly, the present system encompasses a hardware processing resource executing computer-readable program code instructions of software or firmware as well as hardware implementations or any combination.

In accordance with various embodiments of the present disclosure, the methods described herein may be implemented by firmware or software programs executable by any ML model algorithm execution provider hardware processing resource such as a hardware controller 104 or a hardware processing resource 102, 106, 108, and 110. For purposes of the present specification, the term ML model algorithm is meant to be understood as any machine learning or artificial intelligence (AI) algorithm that can be invoked or executed by a hardware processor to receive input data, learn from that data, and provide output to perform the processes of an AI productivity tool software module 162 described herein. Further, in an exemplary, non-limited embodiment, implementations may include distributed hardware processing, component/object distributed hardware processing, and parallel hardware processing. Alternatively, virtual computer system processing may be constructed to implement one or more of the methods or functionalities as described herein.

The present disclosure contemplates a computer-readable medium that includes computer-readable program code instructions (e.g., software algorithms) parameters, and profiles 118 or receives and executes computer-readable program code instructions (e.g., software algorithms) parameters, and profiles 118 responsive to a propagated signal, so that a hardware device connected to a network 142 may communicate voice, video, or data over the network 142. Further, the computer-readable program code instructions (e.g., software algorithms) parameters, and profiles 118 may be transmitted or received over the network 142 via the network interface device or wireless interface adapter 134.

The information handling system 100 may include a set of computer-readable program code instructions (e.g., software algorithms) parameters, and profiles 118 that may be executed to cause the computer system to perform any one or more of the methods or computer-based functions disclosed herein. For example, computer-readable program code instructions (e.g., software algorithms) parameters, and profiles 118 may be executed by a hardware processor 102, GPU 106, EC 104, APU 108, NPU 110 or any other hardware processing resource and may include software agents, or other aspects or components used to execute the methods and systems described herein. Various software modules comprising application computer-readable program code instructions (e.g., software algorithms) parameters, and profiles 118 may be coordinated by an OS 122, and/or via an application programming interface (API). An example OS 122 may include Windows®, Android®, and other OS types. Example APIs may include Win 32, Core Java API, or Android APIs.

In an embodiment, the information handling system 100 may include a disk drive unit 126. The disk drive unit 126 and may include computer-readable program code instructions (e.g., software algorithms) parameters, and profiles 118 in which one or more sets of computer-readable program code instructions (e.g., software algorithms) parameters, and profiles 118 such as firmware or software can be embedded to be executed by the hardware processor 102 (e.g., CPU) or other hardware processing devices such as a GPU 106, an EC 104, an NPU 110, an APU 108, or other hardware processing resource device to perform the processes described herein. Similarly, main memory 112 and static memory 114 may also contain a computer-readable medium for storage of one or more sets of computer-readable program code instructions (e.g., software algorithms) parameters, and profiles 118 described herein. The disk drive unit 126 or static memory 114 also contain space for data storage. Further, the computer-readable program code instructions (e.g., software algorithms) parameters, and profiles 118 may embody one or more of the methods described herein. In a particular embodiment, the computer-readable program code instructions (e.g., software algorithms) parameters, and profiles 118 may reside completely, or at least partially, within the main memory 112, the static memory 114, and/or within the disk drive 126 during execution by the hardware processor 102, EC 104, or GPU 106, NPU 110, APU 108 of information handling system 100.

Main memory 112 or other memory of the embodiments described herein may contain computer-readable medium (not shown), such as RAM in an example embodiment. An example of main memory 112 includes random access memory (RAM) such as static RAM (SRAM), dynamic RAM (DRAM), non-volatile RAM (NV-RAM), or the like, read only memory (ROM), another type of memory, or a combination thereof. Static memory 114 may contain computer-readable medium (not shown), such as NOR or NAND flash memory in some example embodiments. The applications and associated APIs, for example, may be stored in static memory 114 or on the disk drive unit 126 that may include access to computer-readable program code instructions (e.g., software algorithms) parameters, and profiles 118 such as a magnetic disk or flash memory in an example embodiment. While the computer-readable medium is shown to be a single medium, the term “computer-readable medium” includes a single medium or multiple media, such as a centralized or distributed database, and/or associated caches and servers that store one or more sets of machine-readable code instructions. The term “computer-readable medium” shall also include any medium that is capable of storing, encoding, or carrying a set of machine-readable code instructions for execution by a processor or that cause a computer system to perform any one or more of the methods or operations disclosed herein.

In an embodiment, the information handling system 100 may further include a power management unit (PMU) 128 (a.k.a. a power supply unit (PSU)). The PMU 128 may include a hardware controller and executable machine-readable code instructions to manage the power provided to the components of the information handling system 100 such as the hardware processor 102 and other hardware components described herein. The PMU 128 may control power to one or more components including the one or more drive units 126, the hardware processor 102 (e.g., CPU), the EC 104, the GPU 106, APU 108, NPU 110, a video/graphic display device 150, or other wired I/O devices 148 such as the mouse 158, the stylus 154, the keyboard 152, the microphone 160, and the trackpad 156 and other components that may require power when a power button has been actuated by a user. In an embodiment, the PMU 128 may monitor power levels and be electrically coupled to the information handling system 100 to provide this power. The PMU 128 may be coupled to the bus 124 to provide or receive data or machine-readable code instructions. The PMU 128 may regulate power from a power source such as the battery 130 or AC power adapter 132. In an embodiment, the battery 130 may be charged via the AC power adapter 132 and provide power to the components of the information handling system 100, via wired connections as applicable, or when AC power from the AC power adapter 132 is removed.

In a particular non-limiting, exemplary embodiment, the computer-readable medium can include a solid-state memory such as a memory card or other package that houses one or more non-volatile read-only memories. Further, the computer-readable medium can be a random-access memory such as main memory 112 or other volatile re-writable memory such as static memory 114. Additionally, the computer-readable medium can include a magneto-optical or optical medium, such as a disk or tapes or other storage device drive unit 126 to store information received via carrier wave signals such as a signal communicated over a transmission medium. Furthermore, a computer-readable medium 114 can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or machine-readable code instructions may be stored.

In other embodiments, dedicated hardware implementations such as application specific integrated circuits (ASICs), programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses hardware resources executing software or firmware, as well as hardware implementations.

As described in embodiments herein, the information handling system 100 includes an AI productivity tool software module 162 and an AI productivity tool software plug-in 164 to receive user-query input and provide that user-query input to the AI productivity tool subagent 166. In an embodiment, the execution of the computer-readable program code instructions 118 of the AI productivity tool subagent 166 by the hardware processor 102 or any other hardware processing device selects among a plurality of available machine learning (ML) model algorithms 182, 184, 186 maintained within an ML model algorithm database 180 for use with execution of operational steps of the AI productivity tool software module 162 to identify responsive capabilities to be executed by one or more of a plurality of AI productivity tool-enablable software applications 190 according to another embodiment of the present disclosure. As described herein, the computer-readable program code instructions 118 of the AI productivity tool software module 162 and AI productivity tool subagent 166 as well as available ML model algorithms 182, 184, 186 may be executed by a hardware processor 102 or other ML model algorithm execution provider hardware processing resource on the information handling system 100 thereby allowing the methods described herein to be carried out on-the-box such that a wired or wireless network connection to a network is not necessary for operation of the method. In another embodiment, some modules, databases, and/or processing resources such as the ML model algorithms 182, 184, 186 may be maintained on a side-band information handling system or device or at a networked remote server such that a wired or wireless network connection can be made with these side-band devices or remote servers for execution using hardware processing resources and the method may be implemented as described herein.

The AI productivity software tool module 162 may include any artificial intelligence-based productivity tool to assist in interfacing with and execution of one or more AI productivity tool-enablable software applications 190 and receive inputs from a user and generate responses at an information handling system 100. The AI productivity tool software module 162 may be loaded on-the-box by a manufacturer in software and may include chatbot features, virtual assistant features, and other artificial intelligence features that allow a user to provide input to the information handling system 100 and, with generative artificial intelligence processing of a user-query input, execute one or more capabilities that include hardware operations, functions, software services, or responses using one or more AI productivity tool-enablable software applications 190. Examples of some types of AI productivity tool software modules 162 may include Cortana® by Microsoft®, Copilot® by Microsoft®, Siri® by Apple® Inc., Gemini® by Google AIR, ChatGPT® by OpenAI®, and Amazon Alexa® by Amazon®, among others. It is appreciated that the information handling system 100 may include any proprietary AI productivity tool software module 162 installed by an information handling system 100 manufacturer and used to interface with the information handling system 100 and the operations thereon. In various embodiments, the hardware processor 102 or other alternative hardware processing resources of the information handling system 100 may execute computer-readable program code instructions 118 of the AI productivity tool software module 162 with its AI productivity tool plug-in 164 and monitor for user-query input at a microphone 160, keyboard 152, or other input device for the AI productivity tool subagent 166 to engage in determining capability intent actions responsive to the user-query input.

The AI productivity tool software module 162, executing on the hardware processor 102, such as a CPU, or other hardware processing resource (e.g., EC 104, GPU 106, APU 108, or NPU 110), may interface with other hardware components and with the AI productivity tool-enablable software applications 190 as well as one or more ML model algorithms 182, 184, 186 via an AI productivity tool plug-in 164. The AI productivity tool plug-in 164 may be any software or firmware that allows the AI productivity tool subagent 166 to perform those actions responsive to a user-query input at the information handling system 100 based on user-query input (e.g., typed, spoken words, images, etc.) provided from the user. The AI productivity tool plug-in 164 may be used by the AI productivity tool software module 162 and AI productivity tool subagent 166 to interface with any number of AI productivity tool-enablable software applications 190 executing or executable on the information handling system 100 according to embodiments herein.

Again, the information handling system 100 also includes the AI productivity tool subagent 166 associated with the AI productivity tool software module 162. The AI productivity tool subagent 166 may be any software and/or firmware executable by the hardware processor 102 or other ML model algorithm execution provider hardware processing resources 104, 106, 108, 110 of the information handling system 100 to interface with one or more of the plurality of the AI productivity tool-enablable software applications 190 to provide AI enabled capabilities within those AI productivity tool-enablable software applications for responsive hardware, firmware, or software operations, functions, software services, or responses to user input queries.

Examples of AI productivity tool-enablable software applications 190 include a remediation (AMDS) software application, Dell® Optimizer® software application, Dell® Trusted Device® software application, Dell® Display and Peripheral Manager® software application, Alienware® Command Center® (AWCC) software application, Dell® Support Assist® software application, and a virtual assistant module. In an embodiment, the computer-readable program code instructions of the AI productivity tool-enablable software applications 190 and modules described herein may operate wholly “on-box” within the information handling system 100 or be sub-agents on-box for interfacing with remote software systems executing at remote server locations. In an embodiment, the AI productivity tool subagent 166 may be used to direct the execution of various modules in support of one or more identified productivity tool operations of the AI productivity tool-enablable software applications 190 and AI productivity tool software module 162 described herein. Additionally, the AI productivity tool subagent 166 may be provided with access to the BIOS and OS of the information handling system 100. Example of identified productivity tool operations include execution of code instructions of the AI productivity tool software module 162 to determine user-query intent values, match these with generated capability intents, and to execute code instructions of one of the AI productivity tool-enablable software applications 190 to conduct the capability intent actions responsive to the user's query input.

During operation, the hardware processor 102 or other hardware processing resource (e.g., EC 104, GPU 106, CPU, APU 108, or NPU 110) executes computer-readable program code instructions of the AI productivity tool subagent 166 to receive the user-query input from the AI productivity tool software module 162. Having received the user-query input, the AI productivity tool subagent 166 engages with a machine learning model requesting module 176 to have one or more ML model algorithms 182, 184, 186 loaded and executed on the hardware processor in order to complete any number of AI productivity tool operations. These operations may include converting any audio into text format for later operations. Another operation may include determining a query intent value of a user-query input. Yet another operation may include correlating a determined query intent value with a capability intent action to be conducted responsive to the received user-query inputs. In an embodiment, the execution of the computer-readable program code instructions of the AI productivity tool subagent 166 may cause the AI productivity tool subagent 166 to initially identify which of the plurality of ML model algorithms 182, 184, 186 are to be invoked in order to eventually identify a capability associated with any given AI productivity tool-enablable software application 189 that can fulfill the appropriate capability intent action pursuant to the user's user-query input.

For example, the ML model algorithms 182, 184, 186 may include a speech-to-text model algorithm 182 in order to, where necessary, convert any audio user-query input into text or other machine-readable program code instructions for further processing by the AI productivity tool subagent 166. In an embodiment, the speech-to-text model algorithm 182 may include an automatic speech recognition ML model algorithm or other speech recognition ML model algorithm. In another embodiment, the ML model algorithms 182, 184, 186 include a query input-to-intent ML model algorithm 184 that receives the user-query input, and with an embedding algorithm generates a vectorized query intent value for the user-query input for later correlation with a capability intent value. In an embodiment, the ML model algorithms 182, 184, 186 may also include a query intent-to-capability matching ML model algorithm that receives the vectorized query intent value as input and matches the vectorized query intent value to a vectorized capability intent value associated with one or more AI productivity tool-enablable software applications 190 via a similarity correlation algorithm for lexical or semantic matching to identify a responsive capability that can execute a capability intent action responsive to a user-query input received at the AI productivity tool software module 162.

It is appreciated as well that each or any of the individual ML model algorithms 182, 184, 186 for operation steps of the AI productivity tool software module 162 may include a small ML model algorithm variant, a default ML model algorithm variant, and a large ML model algorithm variant. These variants of the ML model algorithms 182, 184, 186 may be grouped together as size-variant ML model algorithms of a similar ML model algorithm identified with a similar or common productivity tool operation. For example, a small ML model algorithm variant may include a “small” variant of the query input-to-intent ML model algorithm 184, a default ML model algorithm variant may include a “default” sized variant of the query input-to-intent ML model algorithm 184, and a large ML model algorithm variant may be a “large” variant of the query input-to-intent ML model algorithm 184.

The speech-to-text ML model algorithm 182 and the query intent-to-capability matching ML model algorithm 186 also, similarly, include “small,” “default,” and “large” variants of their ML model algorithms as well. Each of these size variants of the ML model algorithms 182, 184, 186 may include disparate number of parameters and bit sizes with each of the plurality of available size-variant ML model algorithms and which may yield different levels of precision to, in an embodiment, execute the identified AI productivity-tool operation. These differing size-variant ML model algorithms of each kind of ML model algorithm 182, 184, 186 will have trade-offs between precision of the outputs and ML model algorithm execution provider hardware processing resources consumed or latency of operation among other factors in embodiments herein.

It is appreciated that each type of the ML model algorithms stored within the ML model algorithm database 180 are grouped for a similar or common productivity tool operation identified for operation with the AI productivity tool software module 162 or one of the AI productivity tool-enablable software applications 190. The types of identified AI productivity-tool operations may have one or more size-variants available such that any given ML model algorithm could include a “small,” “default,” and “large” variant for execution by a selected ML model algorithm execution provider hardware processor in order for one or more of AI productivity tool-enablable software applications 190 to perform software services, operations, or responses based on the user-query input. The selected size variant ML model algorithm for the query intent-to-capability matching ML model algorithm 186, for example, may yield disparate levels of precision for output but may also differ in levels of memory and hardware processing resources consumed as well as latency or other aspects affecting QoS of response.

In a more specific example embodiment, the small ML model algorithm variant, default ML model algorithm variant, and large ML model algorithm variant associated with any given ML model algorithms 182, 184, 186 may each include a disparate number of parameters and bit sizes that identify them as a “small,” “default,” and “large” ML model algorithm variant. In an example, a bit size of a ML model algorithms 182, 184, 186 is defined by the number of parameters and the sizes of the parameters used as input to the ML model algorithm variant that describe the quantization technique of a given size-variant of the ML model algorithm 182, 184, 186 and may relate to levels of input received, and processing levels or recursions executed. In an example embodiment, a look-up table may be provided that specifically defines each of the small ML model algorithm variant, the default ML model algorithm variant, and the large ML model algorithm variant of each ML model algorithm 182, 184, 186 based on this criterion. An example look-up table is presented in Table 1 below:

| EP/Size | Large | Medium or “default” | Small |
|---|---|---|---|
| CPU | Llama30b-cpu | Llama30b-cpu-int8 | Llama7b-cpu-int8 |
| GPU | Llama30b-gpu | Llama30b-gpu-fp16 | Llama7b-gpu-fp16 |
| NPU | Llama30b-npu | Llama30b-npu-int8 | Llama30b-npu-int4 |
| . . . | . . . | . . . | . . . |

The above table shows a plurality of Llama autoregressive large language models (LLMs) that each may include disparate number of parameters and disparate quantization sizes. For example, Llama7b-gpu-fp16 identifies a Llama autoregressive LLM that has 7 billion parameters, which has been optimized to run on a graphical processing unit (GPU) and has a quantization size of 16 bits. It is appreciated that every type of ML model algorithm may each include its own set of variants that include a large, default or medium, and small variant such that the workload orchestrator may select the appropriate variant of a given ML model algorithm 182, 184, 186 to execute during the identified productivity-tool operations common to those grouped size-variants described herein depending on the state of the hardware components detected at the information handling system 100.

Again, it is appreciated that execution of the computer-readable program code instructions of the AI productivity tool subagent 166 allows the AI productivity tool subagent 166 to initially determine which of the ML model algorithms 182, 184, 186 are required to be invoked in order to identify a capability associated with any AI productivity tool-enablable software application 189. Indeed, the AI productivity tool subagent 166 may determine, prior to invocation of any of the ML model algorithms 182, 184, 186, which size-variant ML model algorithms associated with any given ML model algorithm 182, 184, 186 could be executed in order to precisely and accurately identify the capability associated with any AI productivity tool-enablable software application 189. In an embodiment, the AI productivity tool subagent 166 may access a look-up table such as the Table 1 above in order to determine which of the size-variant ML model algorithms could be invoked in order to get accurate and precise results without unnecessarily increasing hardware processing resources at any of the available in-band, side-band, and networked ML model algorithm execution provider hardware processors detected in the present system and method.

In embodiments herein, plural hardware processing resources may be available to execute one or more of the operation steps using ML model algorithms of the AI productivity tool software module 162. Those ML model algorithm execution provider hardware processors may include in-band ML model algorithm execution provider hardware processors 102, 104, 106, 108, 110, side-band or PAM populated and enumerated ML model algorithm execution provider hardware processors 198, and networked edge populated and enumerated ML model algorithm execution provider hardware processors 197. In order to access which in-band, side-band, and networked ML model algorithm execution provider hardware processors are available, the information handling system 100 may execute computer-readable program code instructions of a system environment component discovery software application 194. In an embodiment, the system environment component discovery software application 194 gathers runtime telemetry data describing accessibility and current processing consumption state of a plurality of in-band, side-band, and networked ML model algorithm execution provider hardware processors. The runtime telemetry data may, in some example embodiments, include data transfer rates between the AI productivity tool subagent and ML model algorithm execution provider hardware processors (e.g., 102, 104, 106, 108, 110) in-band on-the-box and accessible via side-band connection (e.g., via a PAN to 198) and networked connections (e.g., via a network 142 to 197), available RAM at the information handling system, current processing resource consumption of each of the available ML model algorithm execution provider hardware processors, processing capabilities of each of the available ML model algorithm execution provider hardware processors, and supported runtime services that deploy execution of any given ML model algorithm across one or multiple ML model algorithm execution provider hardware processors. It is appreciated that other types of telemetry data may be used to help determine which of the ML model algorithm execution provider hardware processors can be used to execute the ML model algorithms 182, 184, 186 described herein. Further, other types of telemetry data may be used to help determine under what conditions the execution of any given ML model algorithm 182, 184, 186 is completed on any given ML model algorithm execution provider hardware processor or switched to another ML model algorithm execution provider hardware processor.

As mentioned, the execution of the computer-readable program code instructions of the system environment component discovery software application 194 also identifies available (and accessible) ML model algorithm execution provider hardware processors either via in-band (e.g., bus 124), side-band (e.g., via a PAN to 198), or network connections (e.g., via network 142 to 197). In an example embodiment, the system environment component discovery software application 194 may access one or more hardware drivers 190 to detect the availability and accessibility of in-band ML model algorithm execution provider hardware processors within the information handling system 100. In another embodiment, the execution of the system environment component discovery software application 194 may access a baseboard management controller executing a hardware management engine that is used to discover those side-band (e.g., 198) and networked (e.g., 197) ML model algorithm execution provider hardware processors that are made available to the information handling system 100. The baseboard management controller executing a hardware management engine may identify a population of operatively coupled PAN or networked device for further enumeration of those available side-band (e.g., 198) and networked (e.g., 197) ML model algorithm execution provider hardware processors in embodiments herein.

The baseboard management controller of system environment component discovery software application 194 executes a hardware management engine that operates to ping a hardware management engine agent operating at a PAN connected hardware device 197, such as a docking station, or a networked remote server 198 in an embodiment. In an embodiment, the baseboard management controller of the system environment component discovery software application 194 executing with the hardware processor 102 uses the computer-readable program code of the workload orchestrator 196 to generate a trust relationship between the information handling system and side-band ML model algorithm execution provider hardware processors of the PAN connected peripheral hardware devices 198, such as a docking station, by establishing a trusted communication link and receive, securely, the requested runtime telemetry data. Similarly, the baseboard management controller of the system environment component discovery software application 194 executing with the hardware processor 102 uses the computer-readable program code of the workload orchestrator 196 to generate a trust relationship between the information handling system and networked ML model algorithm execution provider hardware processors of networked remote servers 197 by establishing a trusted communication link and receive, securely, the requested runtime telemetry data. Computer readable code instructions of hardware management engine agents at each enumerated PAN connected peripheral hardware device 198, such as the docking station, or at each enumerated networked remote server 197 may report telemetry data for those side-band and networked ML model algorithm execution provider hardware processors that are made available via side-band or network wireless or wired communications to the information handling system in an embodiment. The present specification contemplates that any type of discovery method and system may be implemented herein to both discover each ML model algorithm execution provider hardware processor, determine if those ML model algorithm execution provider hardware processors are accessible to the information handling system 100, and further determine if those ML model algorithm execution provider hardware processors are available (e.g., processing resources available) for execution of each or any of the ML model algorithms 182, 184, 186 for operation steps of the AI productivity tool software module 162 described herein.

In an embodiment, the computer-readable program code instructions 118 of the hardware drivers 190 may also be used by the system environment component discovery software application 194 to identify the existence of one or more of the in-band, side-band, and networked ML model algorithm execution provider hardware processors. Additionally, the hardware drivers 190 may also identify any telemetry data associated with the operation of the ML model algorithm execution provider hardware processing resources such as current consumption of processing resources (for example, peta operations per second (pTops), exa operations per second (cTops), current workloads and usage metrics), RAM occupancy, latency of execution, and other metrics. In some embodiments, additional telemetry data may include individual application usage of ML model algorithms and system resources, thermal effects on, for example, the battery function, or latencies depending on the location of the ML model algorithms in the topology of the information handling system 100. Further embodiments of telemetry data may include energy usage estimation engine (E3) data for carbon impacts by the operations of the information handling system 100.

It is appreciated that any other runtime telemetry data may be retrieved while any of the ML models are executed or are about to be executed and may be stored for future execution of similar ML model algorithms to anticipate telemetry data changes for selection among available size-variants of an ML model algorithm for a common identified productivity-tool operation. It is also appreciated that any runtime telemetry data may be retrieved using any hardware drivers 190 and may include, for example, a hardware driver associated with the PMU that provides battery relative state-of-charge (RSOC) data (e.g. a range of 0% to 100%). It is appreciated that any other telemetry data may be acquired by the system state component discovery software application 184 via the hardware drivers 188 that would provide additional information related to resource consumptions at the information handling system 100 as the ML model algorithm size variants are being executed by a ML model algorithm execution provider hardware processing resource 102, 104, 106, 108, 110 or if offloaded to one or more PAN populated and enumerated ML model algorithm execution provider hardware processing resources 198 or edge populated and enumerated ML model algorithm execution provider hardware processing resources 197.

In a specific example embodiment, a hardware processing device may execute computer-readable program code instructions 118 of a Dell® Telemetry Manager®. The execution of the computer-readable program code instructions 118 of the Dell® Telemetry Manager® may automatically cause this telemetry data to be retrieved and sent to the system environment component discovery software application 194 for processing and use in determining, by the workload orchestrator 196, whether a pending execution by an in-band, side-band, and networked ML model algorithm execution provider hardware processor and a selection among a plurality of available size-variant ML model algorithms 182, 184, 186 is appropriate. Appropriateness of the executing ML model algorithm execution provider hardware processing resource and selected size-variant ML model algorithm is determined from whether or not they meet satisfactory quality of service metric threshold for functions of the information handling system 100 and meet a ML model algorithm confidence threshold score for output accuracy under the current operating conditions detected in the telemetry data gathered by execution of the system environment component discovery software application 194.

Therefore, the hardware processing device (e.g., 102, 104, 106, 108, 110) may execute computer-readable program code instructions 118 of the workload orchestrator 196 to initially receive the data describing the gathered runtime telemetry data from the system environment component discovery software application 194. In an embodiment, the execution of the computer-readable program code instructions 118 of the workload orchestrator 196 may also, through the use of the runtime telemetry data, continuously or repeatedly monitor the consumption of processing resources of each of the in-band, side-band, and networked ML model algorithm execution provider hardware processors. Additionally, execution of the workload orchestrator 196 may determine if the execution of the ML model algorithms 182, 184, 186 (in any size-variant ML model algorithm) by an identified ML model algorithm execution provider hardware processing resource (in-band, side-band, and/or networked ML model algorithm execution provider hardware processor) would meet a quality of service (QoS) metric threshold used to optimize the operating environment within the information handling system. Indeed, where the processing resource consumption at some ML model algorithm execution provider hardware processor exceeds or falls below a QoS metric threshold for satisfactory execution of processes on the information handling system, the workload orchestrator 196 may determine that that particular ML model algorithm execution provider hardware processor is not available to execute a ML model algorithm 182, 184, 186, in any size-variant ML model algorithm, as described herein.

Additionally, the workload orchestrator 196 may receive the runtime telemetry data from the system environment component discovery software application 194 that includes descriptions of the individual ML model algorithm execution provider hardware processors made available to the information handling system to determine whether those ML model algorithm execution provider hardware processors are better configured to execute ML model algorithms 182, 184, 186. It is appreciated that the execution of some of the ML model algorithms 182, 184, 186 may be better fit for some types of ML model algorithm execution provider hardware processors such as NPUs 110, for example. Although other hardware processors (CPUs, ECs 104, GPUs 106, APUs 108, NPUs 110) may be used to execute these ML model algorithms 182, 184, 186 in order to identify a capability associated with any AI productivity tool-enablable software application 190, NPUs 110 in a particular example, are specialized hardware processing devices that are designed to accelerate AI and ML applications and execute certain types of ML model algorithms. Other ML model algorithm execution provider hardware processing resources including CPUs 102, ECs 104, GPUs 106, APUs 108, or NPUs 110 may be better suited for different types of executions for other ML model algorithms or more efficient for particular size-variants of those ML model algorithms in embodiments herein. As such, the workload orchestrator 196 may set a preference to execute those ML model algorithms 182, 184, 186 on NPUs (e.g., 110) that are more particularly suited to execution on an NPU 110 when one is made available to and detected by the information handling system 100 via the system environment component discovery software application 194 in one example embodiment.

Still further, the workload orchestrator 196 may monitor currently-executing ML model algorithms 182, 184, 186 on each of the in-band, side-band, and networked ML model algorithm execution provider hardware processors. For example, a CPU may have been tasked with executing the speech-to-text ML model algorithm 182 in order to continually process user-query input as it is received at the AI productivity tool software application 162. Other ML model algorithms 182, 184, 186 may concurrently be executed on the NPU 110 such as the query input-to-intent ML model algorithm 184 and query intent-to-capability matching ML model algorithm 186 as a result of these ML model algorithms requiring higher processing resources to execute them. Thus, in this example, the CPU (e.g., hardware processor 102) may be selected where hardware processing resources are light and the QoS metric threshold for that CPU is still met (e.g., not exceeded or fallen below depending on the QoS metric or metrics).

In the course of operation of the information handling system 100, other computer-readable program code instructions may be executed on the hardware processor 102 (e.g., CPU) or on other executing CPUs, ECs 104, GPUs 106, NPUs 110, such as background software applications and foreground software applications. A CPU 102 will be addressed in the course of the example embodiment discussed, but similar issues may apply to other ML model algorithm execution provider hardware processors such as CPUs 102, ECs 104, GPUs 106, or NPUs 110. The execution of these software applications may take up significant processing resources at the CPU (e.g., a foreground gaming application and/or a background antivirus/antimalware application). The runtime telemetry data received by the workload orchestrator 196 includes data indicating that the CPU is available at workload orchestrator 196, but that current processing consumption data of the CPU currently exceeds or falls below the QoS metric threshold. In this instance, the workload orchestrator 196 will not select the CPU to execute one or more of the ML model algorithm executions 182, 184, 186. Instead, because the information handling system 100 in FIG. 1 includes an NPU 110 the workload orchestrator 196 may use the NPU 110, another hardware processing resource (e.g., 104, 106, or 108) as the ML model algorithm executing ML model algorithm execution provider hardware processor along with the option to extend or share the execution of one or more the ML model algorithms 182, 184, 186 to any other in-band (e.g., 104, 106, 108), side band (e.g., any other NPUs discovered in a PAN at PAN populated and enumerated ML model processing devices 198), and networked ML model algorithm execution provider hardware processors (e.g., identified over a network connection via the wireless interface adapter 134 at edge populated and enumerated ML model processing devices 197). Thus, the workload orchestrator 196 may aggregate the runtime telemetry data, discover current processing resource consumption metrics at each of the in-band, side-band, and networked ML model algorithm execution provider hardware processors, and assign the execution of one or more the ML model algorithms 182, 184, 186 to those ML model algorithm execution provider hardware processors that have not exceeded or fallen below the QoS metric threshold, depending on the QoS metric threshold used. In an example embodiment, the QoS metric threshold may be set as a percentage of processing resources consumed at each of the individual available ML model algorithm execution provider hardware processors.

As described herein, the execution of a large ML model algorithm variant of any of the ML model algorithms 182, 184, 186 used for an identified productivity-tool operation type via any in-band, side-band, and networked ML model algorithm execution provider hardware processor results in a relatively a higher consumption of power and hardware processing resources relative to the small ML model algorithm variant of that same or common identified productivity-tool operation type of ML model algorithms 182, 184, 186. However, the precision of the output provided via execution of the small variant of the ML model algorithms 182, 184, 186 of the common identified productivity-tool operation type of ML model algorithm 182, 184, 186 may be significantly lower than the precision of the output provided via execution of the large variant of the ML model algorithm 182, 184, 186. In an embodiment, therefore, the workload orchestrator 196 and system environment component discovery software application 194 may operate together in order to optimize quantization techniques (e.g., levels of input received and processing levels for recursions, etc.) that includes a focus on selecting the appropriate size-variant ML model algorithm.

In some embodiments, the computer readable code instructions of the workload orchestrator 196 and the system environment component discovery software application 194 executes to determine an appropriate size-variant ML model algorithm that consumes a least amount of processing resources, a least amount of power, a least amount of memory bandwidth, a lowest latency, or a highest throughput necessary for completing an operation step of the AI productivity tool software application 162 without losing too much accuracy and precision in the output of the selected or to-be selected size-variant ML model algorithms of an identified common AI productivity-tool operation step or steps in embodiments herein. Accordingly, each size-variant ML model algorithm option for the ML model algorithms 182, 184, 186 may have an output confidence threshold score, related to the correlation probability to an output match, that that ML model algorithm uses to determine a provided output based on the provided plurality of input parameters used or available in some embodiments herein. Such an ML model algorithm output confidence score may be assessed for the size-variant ML model algorithms and depend on input parameters to be provided and aspects such as the user query input received. For example, user query inputs which may be vague or specific may make correlation more difficult or simpler in terms of recursive processing by the ML model algorithms 182, 184, 186 in some embodiments. In other embodiments, a length of user query input may increase the inputs to the ML model algorithms 182, 184, 186 in embodiments herein. This selection of size-variant ML model algorithms 182, 184, 186 for precision also maintains balance of QoS metrics to not exceed or fall below the QoS metric threshold that would otherwise impact the usage of the information handling system 100 by the user. In an embodiment, the QoS metrics threshold may be set to and include a specific level of consumption ML model algorithm execution provider ML model algorithm execution provider hardware processor (e.g., >eTops/second) or RAM occupancy above which some or all processes executing on the information handling system 100, including those of AI productivity-tool operations, will be negatively impacted such that the impact may be noticed by a user. In another embodiment, the QoS metrics threshold may be set to a specific level of power consumption (e.g., >40 W/hour) relative to ongoing available battery power.

In an embodiment, when the workload orchestrator 190 determines that the execution of a selected size-variant of each ML model algorithm 182, 184, 186 from among an available plurality of the size-variant ML model algorithms 182, 184, 186 by a selected in-band, side-band, or networked ML model algorithm execution provider hardware processor does not meet the QoS metric threshold, the workload orchestrator 190 may switch to another or second in-band, side-band, or networked ML model algorithm execution provider hardware processor used to execute the selected size-variant of the ML model algorithms 182, 184, 186. This change is a result of the system environment component discovery software application 194 and workload orchestrator 196 determining that ML model algorithm execution provider hardware processor consumption exceeded a QoS metric (e.g., processing resource consumption level) or fell below a QoS metric (e.g., processing or transmission latency times) at the previous in-band, side-band, or networked ML model algorithm execution provider hardware processor. As a result, a different in-band, side-band, or networked ML model algorithm execution provider hardware processor may be used instead. This may occur where, for example, the hardware processor 102 (e.g., CPU) was the originally selected in-band ML model algorithm execution provider hardware processor but other processes are or will be executed on the hardware processor 102 and the execution of the selected size-variant of the ML model algorithms 182, 184, 186 will result in the QoS metric being exceeded or fall below a QoS metric threshold. In an embodiment, the workload orchestrator 190 may provide instructions to the workload orchestrator 196 to switch from the first in-band ML model algorithm execution provider hardware processor to the second in-band, side-band, or networked ML model algorithm execution provider hardware processor.

In another embodiment, the workload orchestrator 190 may determine that the execution of the selected size-variant of a given ML model algorithm 182, 184, 186 selected from among a plurality of available size-variant of the given ML model algorithms 182, 184, 186 of an identified AI productivity-tool operation type by the selected ML model algorithm execution provider hardware processor does not meet the QoS metric threshold. In this embodiment, the workload orchestrator 190 switches the selected size-variant of the ML model algorithm 182, 184, 186 to another or second size-variant of the ML model algorithm 182, 184, 186 to be executed on the ML model algorithm execution provider hardware processor in an embodiment. The switching from a first selected variant of the ML model algorithm 182, 184, 186 to another or second variant of the ML model algorithm 182, 184, 186 from among a plurality of available variants of the ML model algorithms 182, 184, 186 may be done when the workload orchestrator 190 determines that a QoS metric threshold has been exceeded or the QoS falls below some threshold and that a lower resolution or accuracy of output from another variant of the ML model algorithms 182, 184, 186 (e.g., from a default ML model algorithm variant or a small ML model algorithm variant) would be sufficient to complete the identified productivity-tool operation type process described herein. In an embodiment, the workload orchestrator 190 may switch from executing the first variant of the ML model algorithm 182, 184, 186 to executing the second variant of the ML model algorithms 182, 184, 186.

In an embodiment, the workload orchestrator 190 may engage in a confidence scoring process that calculates a confidence score related to the selection of the execution of any given ML model algorithms 182, 184, 186 and/or size-variant of any given ML model algorithm 182, 184, 186 by any selected in-band, side-band, or networked ML model algorithm execution provider hardware processor. This confidence score relates to the precision in executing the identified productivity-tool operation type common to the grouped plurality of available size-variants of the ML model algorithms 182, 184, 186. In an embodiment, the confidence score may be provided during the execution of the ML model algorithms 182, 184, 186 (e.g., variants of the ML model algorithms 182, 184, 186) with the probabilities of each output class in the execution of the ML model algorithm 182, 184, 186 that the ML model algorithm 182, 184, 186 is predicting serving as the confidence score. Thus, in those embodiments where the ML model algorithms 182, 184, 186 are probabilistic, the output probability is used as the confidence score described herein.

In an example embodiment, a similarity search (e.g., a semantic search) correlation probability for that operation step of an AI productivity tool software module 162 may serve as the confidence score for that ML model algorithm size-variant with the score being 1-cosine_distance (user_input, known_intent) where the cosine_distance is between 0 and 1 such that the more confident values are close to 0. Each ML model algorithm size variant may include an output correlation score for the output generated during its execution of an operation step for the AI productivity tool software module 162 identifying and executing a responsive capability to a received user query input. Thus, a maximum score over all known_intent values is the overall score used to decide the confidence score in some embodiments. This ML model algorithm output confidence score may change depending on the input parameters, such as size of inputs, to the currently executing ML model algorithm size-variant. In embodiments herein, the ML model algorithm output confidence score may be affected by the user query input received, for example, where a vague user query input or a longer user query input may require a more robust ML model algorithm size-variant for execution of an operation step of the AI productivity tool software module 162 in identifying or executing a responsive capability intent action to a received user query input.

Thus, if the output from the execution of a specific, selected ML model algorithm 182, 184, 186 for an identified productivity-tool operation type (e.g., embedding an identified query intent value or matching to a capability intent value) is provided via output from the small variant of the query input-to-intent ML model algorithm and determined to not have a high enough ML model algorithm output confidence score to meet a threshold ML model algorithm output confidence score, an imprecise determined query intent value or an imprecise lexical or semantic similarity matching to a capability intent may result that is impactful to operations of the AI productivity tool software module 162 in an embodiment. In such an embodiment, the user-query input is again run through a relatively larger variant of a ML model algorithms 182, 184, 186 (e.g., a default ML model algorithm variant or a large ML model algorithm variant of the query intent determination or query intent-to-capability matching ML model algorithm) at that AI productivity tool software module process operation step in order to increase the confidence score for a more precise result in responding to a user query input. This may be done while also working within the constraints of the QoS metric thresholds such that a sufficient level of resources are consumed to minimize or not impact other hardware processing on the information handling system 100. In embodiments herein, the confidence of the output from the ML model algorithms 182, 184, 186 is monitored to remain sufficient for execution of identified productivity-tool operation for the AI productivity tool software module 162. In an embodiment, the switch between in-band, side-band, and networked ML model algorithm execution provider hardware processor and selected size-variants of the ML model algorithms 182, 184, 186 may be completed within a feedback loop process in order to achieve these goals described herein.

The systems and methods described herein provides for the identification, registration, and assessment of availability of any number of in-band, side-band, or networked ML model algorithm execution provider hardware processors for use in execution of an AI productivity tool software module 162. The selection among any given in-band, side-band, and networked ML model algorithm execution provider hardware processor is also based on current operating conditions of the information handling system such that QoS metric thresholds are met which would otherwise affect the operation of the information handling system to a degree that would be noticeable to the user. By also allowing the execution of the ML model algorithms 182, 184, 186 in their various size variants to be switch amongst themselves as well as from first in-band, side-band, or networked ML model algorithm execution provider hardware processor to a second in-band, side-band, or networked ML model algorithm execution provider hardware processor, the QoS metric thresholds are not exceeded and the user does not notice any reduction in processing within the information handling system 100 while maintaining sufficient ML model algorithm output confidence levels.

When referred to as a “system,” a “device,” a “module,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, controller, or module can include hardware processing resources executing software, including firmware embedded at a device, such as an Intel® brand processor, AMD® brand processors, Qualcomm® brand processors, or other processors and chipsets, or other such hardware device capable of operating a relevant software environment of the information handling system. The system, device, controller, or module can also include a combination of the foregoing examples of hardware or hardware executing software or firmware. Note that an information handling system can include an integrated circuit or a board-level product having portions thereof that can also be any combination of hardware and hardware executing software. Devices, modules, hardware resources, or hardware controllers that are in communication with one another need not be in continuous communication with each other, unless expressly specified otherwise. In addition, devices, modules, hardware resources, and hardware controllers that are in communication with one another can communicate directly or indirectly through one or more intermediaries.

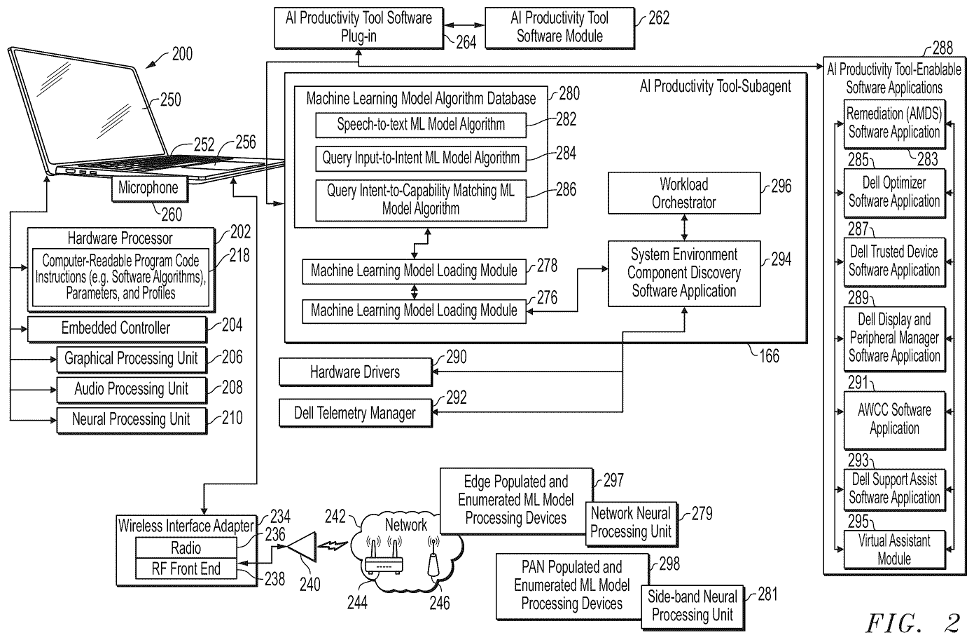

FIG. 2 is a graphic and block diagram illustrating an information handling system 200 that includes computer-readable program code instructions of an AI productivity tool software module 262 to determine AI productivity tool-enablable software applications 289 having responsive software services, operations, or other capabilities by selecting among available in-band, side-band, or networked ML model algorithm execution provider hardware processors used to execute the ML model algorithms according to another embodiment of the present disclosure. As described herein, the information handling system 200 in FIG. 2 is shown as a laptop-type information handling system 200. The information handling system 200 may include a video display device 250 to provide output to the user as well as a keyboard 252, a touchpad 256, and microphone 260 for the user to provide input to the information handling system 200.

During operation of the information handling system 200, a user may engage in AI-supported capability intent actions using an AI productivity tool software module 262 that leverages AI technologies, including one or more ML model algorithms, described herein in order to execute operation steps to identify and execute responsive service, hardware, or software operation capabilities in response to a user-query input. Again, to facilitate this, the information handling system 200 may include an AI productivity tool software module 262 and an AI productivity tool subagent 266 to select among a plurality of available ML model algorithms 281, 282, 283, any or each of which may include size-variants thereof, to be executed by one or more available in-band, side-band, and networked ML model algorithm execution provider hardware processors in embodiments herein. The ML model algorithms 281, 282, 283, any or each of which may include size-variants thereof, are executed for the one or more identified AI productivity-tool operation steps to process received user-query inputs and determine responsive capabilities by one or more available in-band, side-band, or networked ML model algorithm execution provider hardware processors.

These responsive capabilities, when determined, may then be executed via one or more AI productivity tool-enablable software applications 288 or execution of hardware or firmware operations according to an embodiment of the present disclosure. As described herein, the AI productivity tool software module 262 and AI productivity tool subagent 266 may be executed by a hardware processor 202 or other hardware processing device (e.g., EC 204, GPU 206, APU 208, NPU 210) on the information handling system 200 thereby allowing the methods described herein to be carried out at the information handling system on-the-box such that a wired or wireless network connection to a network is not necessary for operation of the method. In another embodiment, some modules, databases, and/or hardware processing resources may be maintained on an auxiliary PAN-connected information handling system, PAN-connected peripheral device, or at a remote server such that a wired or wireless network connection can be made with alternative, operatively connected hardware processing resources and the method may be implemented as described herein.

The information handling system 200 includes an AI productivity tool software module 262 and an AI productivity tool software plug-in 264 to receive user-query input and provide that user-query input to the AI productivity tool subagent 266. In an embodiment, the execution of the computer-readable program code instructions of the AI productivity tool subagent 266 by the hardware processor 202 or any other hardware processing device selects among a plurality of available machine learning (ML) model algorithms 282, 284, 286, any or each of which may include size-variants thereof, maintained within an ML model algorithm database 280 for use with execution of operational steps of the AI productivity tool software module 262 or any of a plurality of AI productivity tool-enablable software applications 288 according to another embodiment of the present disclosure. As described herein, the computer-readable program code instructions of the AI productivity tool software module 262 and AI productivity tool subagent 266 as well as available ML model algorithms 282, 284, 286 may be executed by a hardware processor 202 or other ML model algorithm execution provider hardware processing resource in-band, on-the-box of the information handling system 200 thereby allowing the methods described herein to be carried out on-the-box such that a wired or wireless network connection to a network is not necessary for operation of the method. However, some modules, databases, and/or processing resources such as the ML model algorithm execution provider hardware processors (e.g., a side-band NPU 281 or networked NPU 279) and modules such as versions of the ML model algorithms 282, 284, 286, and any size-variants thereof, may be maintained on an auxiliary PAN-connected peripheral device with hardware processing resources or at a remote server such that a wired or wireless network connection can be made with these remote ML model algorithm execution provider hardware processors and versions of the ML model algorithms 282, 284, 286, and any size-variants thereof and as implemented in embodiments described in the present disclosure.

The AI productivity software tool module 262 may include any artificial intelligence-based productivity tool to assist in interfacing with and execution of one or more AI productivity tool-enablable software applications 288 and receive inputs from a user and generate responses at an information handling system 200. The AI productivity tool software module 262 may be loaded on-the-box by a manufacturer in software and may include chatbot features, virtual assistant features, and other artificial intelligence features that allow a user to provide input to the information handling system 200 and, with generative artificial intelligence processing of a user-query input, execute one or more capabilities that include hardware operations, functions, software services, or responses using one or more AI productivity tool-enablable software applications 288. It is appreciated that the information handling system 200 may include any proprietary AI productivity tool software module 262 installed by an information handling system 200 manufacturer and used to interface with the information handling system 200 and the operations thereon. In various embodiments, the hardware processor 202 or other alternative hardware processing resources of the information handling system 200 may execute computer-readable program code instructions of the AI productivity tool software module 262 with its AI productivity tool plug-in 264 and monitor for user-query input at a microphone 260, keyboard 252, or other input device for the AI productivity tool subagent 266 to engage in determining capability intent actions responsive to the user-query input.

The AI productivity tool software module 262, executing on the hardware processor 202, such as a CPU, or other hardware processing resource (e.g., EC 204, GPU 206, APU 208, or NPU 210), may interface with other hardware components and with the AI productivity tool-enablable software applications 288 as well as one or more ML model algorithms 282, 284, 286 via an AI productivity tool plug-in 264. The AI productivity tool plug-in 264 may be any software or firmware that allows the AI productivity tool subagent 266 to perform responsive capability intent actions to a user-query input at the information handling system 200 based on the user-query input (e.g., typed, spoken words, images, etc.) provided from the user. The AI productivity tool plug-in 264 may be used by the AI productivity tool software module 262 and AI productivity tool subagent 266 to interface with any number of AI productivity tool-enablable software applications 288 executing or executable on the information handling system 200 according to embodiments herein.

Again, the information handling system 200 also includes the AI productivity tool subagent 266 associated with the AI productivity tool software module 262. The AI productivity tool subagent 266 may be any software and/or firmware executable by the hardware processor 202 or other ML model algorithm execution provider hardware processing resources 204, 206, 208, 210 of the information handling system 200 to perform those operational steps or actions of the AI productivity tool software module 262 to identify and interface with one or more of the plurality of the AI productivity tool-enablable software applications 288 to provide AI enabled capabilities within those AI productivity tool-enablable software applications for responsive hardware, firmware, or software operations, functions, software services, or responses to user input queries.

Examples of AI productivity tool-enablable software applications 288 include a remediation (AMDS) software application 283, Dell® Optimizer® software application 285, Dell® Trusted Device® software application 287, Dell® Display and Peripheral Manager® software application 289, Alienware® Command Center® (AWCC) software application 291, Dell® Support Assist® software application 293, and a virtual assistant module 295. In an embodiment, the computer-readable program code instructions of the AI productivity tool-enablable software applications 288 and modules described herein may operate wholly “on-box” within the information handling system 200 or be sub-agents on-box for interfacing with remote software systems executing at remote server locations. In an embodiment, the AI productivity tool subagent 266 may be used to direct the execution of various modules in support of one or more identified productivity tool operations of the AI productivity tool-enablable software applications 288 and AI productivity tool software module 262 described herein. Additionally, the AI productivity tool subagent 266 may be provided with access to the BIOS and OS of the information handling system 200. Example of identified productivity tool operations include execution of code instructions of the AI productivity tool software module 262 to determine user-query intent values, match these with generated capability intents, and to execute code instructions of one of the AI productivity tool-enablable software applications 288 to conduct the capability intent actions pursuant to the user's query input.

During operation, the hardware processor 202 or other hardware processing resource (e.g., EC 204, GPU 206, CPU, APU 208, or NPU 210) executes computer-readable program code instructions of the AI productivity tool subagent 266 to receive the user-query input from the AI productivity tool software module 262. Having received the user-query input, the AI productivity tool subagent 266 engages with a machine learning model requesting module 276 to have one or more ML model algorithms 282, 284, 286, each or any of which may have size-variants, loaded and executed on the hardware processor in order to complete any number of AI productivity operations. These operations may include converting any audio into text format for later operations. Another operation may include determining a query intent value of a user-query input. Yet another operation may include correlating a determined query intent value with a capability intent action to be conducted responsive to the received user-query inputs. In an embodiment, the execution of the computer-readable program code instructions of the AI productivity tool subagent 266 may cause the AI productivity tool subagent 266 to initially identify which of the plurality of ML model algorithms 282, 284, 286 are to be invoked in order to eventually identify a capability associated with any given AI productivity tool-enablable software application 289 that can fulfill the appropriate capability intent action pursuant to the user's user-query input.

For example, the ML model algorithms 282, 284, 286 may include a speech-to-text ML model algorithm 282 in order to, where necessary, convert any audio user-query input into text or other machine-readable program code instructions for further processing by the AI productivity tool subagent 266. In an embodiment, the speech-to-text model algorithm 282 may include an automatic speech recognition ML model algorithm or other speech recognition ML model algorithm. In another embodiment, the ML model algorithms 282, 284, 286 include a query input-to-intent ML model algorithm 284 that receives the user-query input, and with an embedding algorithm generates a vectorized query intent value for the user-query input for later correlation with a capability intent value. In an embodiment, the ML model algorithms 282, 284, 286 may also include a query intent-to-capability matching ML model algorithm that receives the vectorized query intent value as input and matches the vectorized query intent value to a vectorized capability intent value associated with one or more AI productivity tool-enablable software applications 288 via a similarity correlation algorithm for lexical or semantic matching to identify a responsive capability that can execute a capability intent action responsive to a user-query input received at the AI productivity tool software module 262.

It is appreciated as well that the individual ML model algorithms 282, 284, 286 for each operational step of the AI productivity tool software module 262 may include a small ML model algorithm variant, a default ML model algorithm variant, and a large ML model algorithm variant in an example embodiment. Any number of size variants may be available for any individual ML model algorithm 282, 284, 286 or other embodiments herein. These variants of the ML model algorithms 282, 284, 286 may be grouped together as size-variant ML model algorithms of a similar ML model algorithm identified with a similar or common AI productivity tool operation process step to identify or execute responsive capability intent actions. For example, a small ML model algorithm variant may include a “small” variant of the query input-to-intent ML model algorithm 284, a default ML model algorithm variant may include a “default” sized variant of the query input-to-intent ML model algorithm 284, and a large ML model algorithm variant may be a “large” variant of the query input-to-intent ML model algorithm 284. The speech-to-text ML model algorithm 282 and the query intent-to-capability matching ML model algorithm 286 also, similarly, include “small,” “default,” and “large” variants of their ML model algorithms as well.

Each of these size variants of the ML model algorithms 282, 284, 286 may include disparate number of parameters and bit sizes with each of the plurality of available size-variant ML model algorithms and which may yield different levels of precision to, in an embodiment, execute the identified AI productivity-tool operation. These differing size-variant ML model algorithms of each kind of ML model algorithm 282, 284, 286 will have trade-offs between precision of the outputs and ML model algorithm execution provider hardware processing resources consumed or latency of operation among other factors in embodiments herein. It is appreciated that each type of the ML model algorithms stored within the ML model algorithm database 280 are grouped for a similar or common AI productivity tool operation process steps identified for operation with the AI productivity tool software module 262 or one of the AI productivity tool-enablable software applications 288. The types of identified AI productivity-tool operations may have one or more size-variants available such that any given ML model algorithm could include a “small,” “default,” and “large” variant for execution by a selected ML model algorithm execution provider hardware processor in order identify or execute one or more of AI productivity tool-enablable software applications 288 to perform software services, operations, or responses based on the user-query input. The selected size variant ML model algorithm for the query intent-to-capability matching ML model algorithm 286, for example, may have disparate levels of precision for output as a trade-off with amounts of memory and hardware processing resources consumed as well as latency or other aspects affecting QoS metrics of the information handling system when identifying or executing responsive capability intent actions to received user query inputs in embodiments herein.

In a more specific example embodiment, the small ML model algorithm variant, default ML model algorithm variant, and large ML model algorithm variant associated with any given ML model algorithms 282, 284, 286 may each include a disparate number of parameters and bit sizes that identify them as a “small,” “default,” and “large” ML model algorithm variant. In an example, a bit size of a ML model algorithms 282, 284, 286 is defined by the number of parameters and the sizes of the parameters used as input to the ML model algorithm variant that describe the quantization technique of a given size-variant of the ML model algorithm 282, 284, 286 and may relate to levels of input received, and processing levels or recursions executed. For example, size of a user query input or vagueness of a user query input may affect size of input parameters or recursions needed to reach a sufficiently accurate output in some embodiments. In an example embodiment, a look-up table may be provided that specifically defines each of the small ML model algorithm variant, the default ML model algorithm variant, and the large ML model algorithm variant of each ML model algorithm 282, 284, 286 based on this criterion. An example look-up table is presented in Table 1 described in FIG. 1.

Again, it is appreciated that execution of the computer-readable program code instructions of the AI productivity tool subagent 266 allows the AI productivity tool subagent 266 to initially determine which of the ML model algorithms 282, 284, 286 are required to be invoked in order to identify a capability associated with any AI productivity tool-enablable software application 289. Indeed, the AI productivity tool subagent 266 may determine, prior to invocation of any of the ML model algorithms 282, 284, 286, which size-variant ML model algorithms associated with any given ML model algorithm 282, 284, 286 could be executed in order to, with sufficient precision, accurately identify the capability associated with any AI productivity tool-enablable software application 289. In an embodiment, the AI productivity tool subagent 266 may access a look-up table such as the Table 1 above in order to determine which of the size-variant ML model algorithms could be invoked in order to get accurate results without unnecessarily increasing hardware processing resources at any of the available in-band, side-band, or networked ML model algorithm execution provider hardware processors detected as executing a given ML model algorithm 282, 284, 286 in the present system and method.

In order to access which in-band, side-band, and networked ML model algorithm execution provider hardware processors are available, the information handling system 200 may execute computer-readable program code instructions of a system environment component discovery software application 294. In an embodiment, the system environment component discovery software application 294 gathers runtime telemetry data describing accessibility and current processing consumption state of a plurality of in-band, side-band, and networked ML model algorithm execution provider hardware processors determined to be available on-the-box or operatively coupled to the information handling system 200. The runtime telemetry data may, in some example embodiments, include data transfer rates between the AI productivity tool subagent and ML model algorithm execution provider hardware processors (e.g., 202, 204, 206, 208, 210) on-the-box and accessible via in-band, side-band, and networked connections, available RAM at the information handling system, current processing resource consumption of each of the available ML model algorithm execution provider hardware processors, processing capabilities of each of the available ML model algorithm execution provider hardware processors, and supported runtime services that deploy execution of any given ML model algorithm across one or multiple ML model algorithm execution provider hardware processors. It is appreciated that other type of telemetry data may be used to help determine which of the ML model algorithm execution provider hardware processors can be used to execute the ML model algorithms 282, 284, 286 described herein and under what conditions the execution of any given ML model algorithm 282, 284, 286 is completed on any given ML model algorithm execution provider hardware processor or switched to another ML model algorithm execution provider hardware processor.

As mentioned, the execution of the computer-readable program code instructions of the system environment component discovery software application 294 also identifies available (and accessible) ML model algorithm execution provider hardware processors either via in-band, side-band, or network connections. In an example embodiment, the system environment component discovery software application 294 may access one or more hardware drivers 288 to detect the availability and accessibility of in-band ML model algorithm execution provider hardware processors within the information handling system 200. In another embodiment, the execution of the system environment component discovery software application 294 may access a baseboard management controller executing a hardware management engine that is used to discover those side-band and networked ML model algorithm execution provider hardware processors that are made available to the information handling system 200. The baseboard management controller of system environment component discovery software application 294 executes a hardware management engine may operate to ping a hardware management engine agent operating at a PAN connected hardware device 297, such as a docking station, or a networked remote server 298 in an embodiment. Computer readable code instructions of hardware management engine agents at PAN connected hardware device 298, such as the docking station, or a networked remote server 297 may report telemetry data for those side-band and networked ML model algorithm execution provider hardware processors (e.g., 281 and 279 respectively) that are made available via side-band or network wireless or wired communications to the information handling system 200 in an embodiment.

FIG. 2 shows a PAN populated and enumerated ML model processing device 298 that includes, for example, a side-band NPU 281 or other hardware processing resource and which is discoverable per execution of the system environment component discovery software application 294. For example, a PAN-coupled peripheral device, such as a docking station, or other information handling system such as a smart phone, may be one or more PAN populated and enumerated ML model processing devices 298 and have one or more available hardware processing resources, such as side-band NPU 281 in an embodiment. Additionally, FIG. 2 shows an edge populated and enumerated ML model processing device 297 that includes, for example, a networked NPU 279 which is also discoverable per execution of the system environment component discovery software application 294. For example, a network-coupled peripheral device, such as a remote server or other information handling system operatively coupled via a network 242, including a base station 246 or access point 244, may be one or more edge populated and enumerated ML model processing devices 297 and have one or more available hardware processing resources, such as networked NPU 279 in an embodiment.

It is appreciated that any type of ML model algorithm execution provider hardware processor may be discoverable on the PAN, such as via Bluetooth® or via network 242 and which may be used to execute the ML model algorithms 282, 284, 286 and any of their size variants as described in embodiments herein. The present specification contemplates that any type of discovery method and system may be implemented herein to discover each ML model algorithm execution provider hardware processor, determine if those ML model algorithm execution provider hardware processors are accessible to the information handling system 200, and further determine if those ML model algorithm execution provider hardware processors are available (e.g., processing resources available) for execution of the ML model algorithms 282, 284, 286 described herein.

In an embodiment, the computer-readable program code instructions of the hardware drivers 288 may also be used by the system environment component discovery software application 294 to identify the existence of one or more of the in-band, side-band, or networked ML model algorithm execution provider hardware processors such as the hardware processor 102, EC 204, GPU 206, APU 208, NPU 210, side-band NPU 281, and networked NPU 279. Additionally, the hardware drivers 288 may also identify any telemetry data associated with the operation of the ML model algorithm execution provider hardware processing resources (e.g., 202, 204, 206, 208, 210, 279, 291) such as current consumption of processing resources (for example, peta operations per second (pTops), exa operations per second (eTops), current workloads and usage metrics), RAM occupancy, latency of execution, and other metrics. For side-band NPU 281 and networked NPU 279 wired or wireless connectivity telemetry including wired or wireless link quality of service, signal strength, latency, and data bandwidth may also be collected.

In some embodiments, additional telemetry data may include individual application usage of ML model algorithms and system resources, thermal effects on, for example, the battery levels or processing, signal or processing latencies depending on the location of the ML model algorithms in the topology of the information handling system 200, and E3 data for carbon impacts by the operations of the information handling system 200. It is appreciated that any other runtime telemetry data may be retrieved while any of the ML models are executed or are about to be executed and may be stored for future execution of similar ML model algorithms to anticipate telemetry data changes for selection among available size-variants of an ML model algorithm for a common identified productivity-tool operation. It is also appreciated that any runtime telemetry data may be retrieved using any hardware drivers 288 and may include, for example, a hardware driver associated with the PMU that provides battery RSOC data (e.g. a range of 0% to 100%). It is appreciated that any other telemetry data may be acquired by the system state component discovery software application 284 via the hardware drivers 288 that would provide additional information related to resource consumptions at the information handling system 200 as the ML model algorithm size variants are being executed by an ML model algorithm execution provider hardware processing resource 202, 204, 206, 208, 210.

In a specific example embodiment, a hardware processing device may execute computer-readable program code instructions of a Dell® Telemetry Manager®. The execution of the computer-readable program code instructions of the Dell® Telemetry Manager® may automatically cause this telemetry data to be retrieved and sent to the system environment component discovery software application 294 for processing and use in determining, by the workload orchestrator 296, whether a pending execution by an in-band, side-band, and networked ML model algorithm execution provider hardware processor and a selection among a plurality of available size-variant ML model algorithms 282, 284, 286 is appropriate for the current operating conditions detected in the telemetry data gathered by execution of the system environment component discovery software application 294 to maintain QoS metric thresholds for operation of these and other software processes on the information handling system 200 as well as providing ML model algorithm output confidence score levels in embodiments herein.

Therefore, the hardware processing device (e.g., 202 or other on-the-box hardware processing resource) may execute computer-readable program code instructions of the workload orchestrator 296 to initially receive the data describing the gathered runtime telemetry data from the system environment component discovery software application 294 for available in-band, sideband, and networked ML model algorithm execution provider hardware processing resources (e.g., 202, 204, 206, 208, 210, 279, 281). In an embodiment, the execution of the computer-readable program code instructions of the workload orchestrator 296 may also, through the use of the runtime telemetry data, continuously or repeatedly monitor the consumption of processing resources of each of the in-band, side-band, or networked ML model algorithm execution provider hardware processors (e.g., 202, 204, 206, 208, 210, 279, 281). Additionally, execution of the workload orchestrator 296 may determine if the execution of the ML model algorithms 282, 284, 286, in any size-variant ML model algorithm version, by an identified ML model algorithm execution provider hardware processing resource (in-band, side-band, and/or networked ML model algorithm execution provider hardware processor) would meet a quality of service (QoS) metric threshold used to not degrade the operating environment of software processes executing within the information handling system. Indeed, where the processing resource consumption at some ML model algorithm execution provider hardware processor exceeds or falls below a QoS metric threshold, the workload orchestrator 296 may determine that that ML model algorithm execution provider hardware processor is not available to execute a ML model algorithm 282, 284, 286, in any size-variant ML model algorithm, as described herein.

Additionally, the workload orchestrator 296 may receive the runtime telemetry data from the system environment component discovery software application 294 that includes descriptions of the individual ML model algorithm execution provider hardware processors made available to the information handling system to determine whether those ML model algorithm execution provider hardware processors are better configured to execute ML model algorithms 282, 284, 286. It is appreciated that the execution of some of the ML model algorithms 282, 284, 286 may be better fit for some types of ML model algorithm execution provider hardware processors, such as NPUs 210, for example. Although other hardware processors (CPUs, ECs 204, GPUs 206, NPUs 210) may be used to execute these ML model algorithms 282, 284, 286 in order to identify a capability associated with any AI productivity tool-enablable software application 288, each type of hardware device (e.g., 202, 204, 206, 208, 210, 279, 281) may be suited to execution of certain types of ML model algorithms. For example, NPUs 210 in particular are specialized hardware processing devices that are designed to accelerate AI and ML applications and execute ML model algorithms. As such, the workload orchestrator 296 may set a preference to execute the ML model algorithms 282, 284, 286 on NPUs (e.g., 210, or 279, 281) made available to and detected by the information handling system 200 via the system environment component discovery software application 294 given telemetry conditions on-the-box of the information handling system 200 and via wired or wireless connections to side-band or networked hardware processing devices.

Still further, the workload orchestrator 296 may monitor currently-executing ML model algorithms 282, 284, 286 on each of the in-band, side-band, or networked ML model algorithm execution provider hardware processors. For example, a CPU, side-band NPU 281, or networked NPU 279 may have been tasked with executing the speech-to-text ML model algorithm 282 in order to convert the audio input from the microphone 260 into text or other computer-readable language data so that that text may be later interpreted by other ML model algorithms such as the query input-to-intent ML model algorithm 284. Other ML model algorithms 282, 284, 286 may also concurrently be executed on the in-band NPU 210 such as the query input-to-intent ML model algorithm 284 and query intent-to-capability matching ML model algorithm 286. The in-band NPU 210 may be executing these ML model algorithms (e.g., 284, 286) because these ML model algorithms may require higher processing resources to execute them and the in-band NPU 210 is designed to execute these types of AI and ML model algorithms. Thus, in this example, the CPU (e.g., hardware processor 202), side-band NPU 281, or networked NPU 279 may be selected where hardware processing resource requirements are light and the QoS metric threshold for that CPU is not exceeded or otherwise not met. Additionally, side-band NPU 281 or networked NPU 279 may be selected, in some embodiments, where data transmission rates are not a concern and the latency of transmission between the side-band NPU 281 and/or networked NPU 279 and the information handling system 200 is not a concern.

It is appreciated that, during regular use of the information handling system 200 by the user, other computer-readable program code instructions may be executed on the hardware processor 202 (e.g., CPU) or other hardware processor executing an ML model algorithm, such as background software applications and foreground software applications. The execution of these software applications may consume significant processing resources at the CPU (e.g., a foreground gaming application and/or a background antivirus/antimalware application). The runtime telemetry data received by the workload orchestrator 296 includes data indicating that the CPU is an ML model algorithm execution provider hardware processing device to the workload orchestrator 296, but that current processing consumption data of the CPU currently exceeds the QoS metric threshold. In this instance, the workload orchestrator 296 will not select the CPU to execute the ML model algorithm executions 282, 284, 286. Instead, because the information handling system 200 in FIG. 2 includes an in-band NPU 210 or other in-band hardware processing devices (e.g., 204, 206, 208) the workload orchestrator 296 may use the NPU 210 or other in-band hardware processing device as the ML model algorithm executing ML model algorithm execution provider hardware processor along with the option to extend or share the execution of one or more of the ML model algorithms 282, 284, 286 to any other in-band (e.g., 204, 206, 208), side band (e.g., the side-band NPU 291 discovered in a PAN), or networked ML model algorithm execution provider hardware processor (e.g., the networked NPU 279 as identified over a network connection via the wireless interface adapter 234). Thus, the workload orchestrator 296 may aggregate the runtime telemetry data, discover current processing resource consumption metrics at each of the in-band, side-band, and networked ML model algorithm execution provider hardware processors, and assign the execution of the ML model algorithms 282, 284, 286 to those ML model algorithm execution provider hardware processors that have not exceeded the QoS metric threshold. In an example embodiment, the QoS metric threshold may be set as a percentage of processing resources consumed at each of the individual available ML model algorithm execution provider hardware processors. In another example embodiment, the QoS metric threshold may be set as a latency of hardware processing or communications of processed data from each of the individual available ML model algorithm execution provider hardware processors that may be noticeable by a user of the AI productivity tool software module 262.

As described herein, the execution of a large ML model algorithm variant of any of the ML model algorithms 282, 284, 286 used for an identified productivity-tool operation type via any in-band, side-band, or networked ML model algorithm execution provider hardware processor results in a relatively a higher consumption of power and hardware processing resources relative to the small ML model algorithm variant of that same or common identified productivity-tool operation type of ML model algorithms 282, 284, 286. However, the precision of the output provided via execution of the small variant of the ML model algorithms 282, 284, 286 of the common identified productivity-tool operation type of ML model algorithm 282, 284, 286 may be significantly lower than the precision of the output provided via execution of the large variant of the ML model algorithm 282, 284, 286. In an embodiment, therefore, the workload orchestrator 296 and system environment component discovery software application 294 may operate together in order to optimize quantization techniques (e.g., levels of input received and processing levels for recursions, etc.) that includes a focus on selecting the appropriate size-variant ML model algorithm that consumes a least amount of processing resources, a least amount of power, a least amount of memory bandwidth, a lowest latency, or a highest throughput, without losing too much accuracy and precision in the output of the selected or to-be selected size-variant ML model algorithms of an identified common productivity-tool operation type. Accordingly, each size-variant ML model algorithm option for the ML model algorithms 282, 284, 286 may have an output confidence threshold score, related to the correlation probability to a matched output, that that ML model algorithm uses to determine a provided output based on the provided plurality of input parameters used or available in some embodiments herein.

Such an ML model algorithm output confidence score may be assessed for the size-variant ML model algorithms and depend on input parameters to be provided and aspects such as the user query input received. For example, user query inputs which may be vague or specific may make correlation more difficult or simpler in terms of recursive processing by the ML model algorithms 282, 284, 286 in some embodiments. In other embodiments, a length of user query input may increase the inputs to the ML model algorithms 282, 284, 286 in embodiments herein. This selection of size-variant ML model algorithms 282, 284, 286 for precision also maintains balance of QoS metrics to not exceed or fall below the QoS metric threshold that would otherwise impact the usage of the information handling system 200 by the user. In an embodiment, the QoS metrics threshold may be set to and include a specific level of consumption ML model algorithm execution provider ML model algorithm execution provider hardware processor (e.g., >eTops/second) or RAM occupancy above which some or all software processes executing on the information handling system 200, including those of AI productivity-tool operations, will be negatively impacted such that the impact may be noticed by a user. In another embodiment, the QoS metrics threshold may be set to a specific level of power consumption (e.g., >40 W/hour) relative to ongoing available battery power.

In an embodiment, when the workload orchestrator 290 determines that the execution of a selected size-variant of each ML model algorithm 282, 284, 286 from among an available plurality of the size-variant ML model algorithms 282, 284, 286 by a selected in-band, side-band, or networked ML model algorithm execution provider hardware processor does not meet the QoS metric threshold, the workload orchestrator 290 may switch to another or second in-band, side-band, or networked ML model algorithm execution provider hardware processor used to execute the selected size-variant of the ML model algorithms 282, 284, 286. This change is a result of the system environment component discovery software application 294 and workload orchestrator 296 determining that ML model algorithm execution provider hardware processor consumption exceeded a QoS metric (e.g., processing resource consumption level) or fell below a QoS metric (e.g., processing or transmission latency times) at the previous in-band, side-band, or networked ML model algorithm execution provider hardware processor. As a result, a different in-band, side-band, or networked ML model algorithm execution provider hardware processor may be used instead. This may occur where, for example, the hardware processor 202 (e.g., CPU) was the originally selected in-band, side-band, and networked ML model algorithm execution provider hardware processor but other processes are or will be executed on the hardware processor 202 and the execution of the selected size-variant of the ML model algorithms 282, 284, 286 will result in the QoS metric being exceeded or fall below a QoS threshold. In an embodiment, the workload orchestrator 288 may provide instructions to the workload orchestrator 296 to switch from the first in-band, side-band, or networked ML model algorithm execution provider hardware processor to the second in-band, side-band, or networked ML model algorithm execution provider hardware processor.

In another embodiment, the workload orchestrator 288 may determine that the execution of the selected size-variant of a given ML model algorithm 282, 284, 286 for an operation process step of the AI productivity tool software module 262 is selected from among a plurality of available size-variant of the given ML model algorithms 282, 284, 286 of the identified AI productivity-tool operation type by the selected ML model algorithm execution provider hardware processor does not meet the QoS metric threshold. In this embodiment, the workload orchestrator 288 switches the selected size-variant of the ML model algorithm 282, 284, 286 to another or second size-variant of the ML model algorithm 282, 284, 286 to be executed on the current ML model algorithm execution provider hardware processor in an embodiment. The switching from a first selected variant of the ML model algorithm 282, 284, 286 to another second size variant of the ML model algorithm 282, 284, 286 from among a plurality of available variants of the ML model algorithms 282, 284, 286 may be done when the workload orchestrator 288 determines that a QoS metrics threshold has been exceeded or the QoS falls below some threshold in an embodiment. Further, the workload orchestrator 288 may operate to determine that a ML model algorithm output confidence score for a lower resolution or accuracy of output from another size variant of the ML model algorithms 282, 284, 286 (e.g., from a default ML model algorithm variant or a small ML model algorithm variant) would be sufficient to complete the identified productivity-tool operation type process described in an embodiment herein. The workload orchestrator 288 may operate to determine that a ML model algorithm output confidence score requires a higher resolution or accuracy of output from another size variant of the ML model algorithms 282, 284, 286 (e.g., from a default ML model algorithm variant to a large ML model algorithm variant) would be required to complete the identified productivity-tool operation type process described in an embodiment herein. In an embodiment, the workload orchestrator 288 may switch from executing the first size variant of the ML model algorithm 282, 284, 286 to executing the second size variant of the ML model algorithms 282, 284, 286.

In an embodiment, the workload orchestrator 288 may also engage in an ML model algorithm output confidence scoring process that calculates an ML model algorithm output confidence score related to the selection of the execution of any given ML model algorithms 282, 284, 286 and/or size variant of any given ML model algorithm 282, 284, 286 by any selected in-band, side-band, or networked ML model algorithm execution provider hardware processor. This ML model algorithm output confidence score relates to the precision in executing the identified AI productivity-tool operation process step type common to the grouped plurality of available size-variants of the ML model algorithms 282, 284, 286. In an embodiment, the ML model algorithm output confidence score may be provided during the execution of the ML model algorithms 282, 284, 286 (e.g., variants of the ML model algorithms 282, 284, 286) with the probabilities of a match for each output class in the execution of the ML model algorithm 282, 284, 286. This output match probability level, for example a correlation matching confidence level between inputs and an output, determined by that size variant of the ML model algorithm 282, 284, 286 serves as the ML model algorithm output confidence score in an embodiment. For example, in those embodiments where the ML model algorithms 282, 284, 286 are probabilistic, the output probability is used as the ML model algorithm output confidence score described herein.

In an example embodiment, a similarity search (e.g., a semantic search) correlation probability for that operation step of an AI productivity tool software module 262 may serve as the confidence score for that ML model algorithm size-variant with the score being 1-cosine_distance(user_input, known_intent) where the cosine_distance is between 0 and 1 such that the more confident values are close to 0. Each ML model algorithm size variant may include an output correlation score for the output generated during its execution of an operation step for the AI productivity tool software module 262 identifying and executing a responsive capability to a received user query input. Thus, a maximum score over all known intent values is the overall score used to decide the ML model algorithm output confidence score in some embodiments. This ML model algorithm output confidence score may change depending on the input parameters, such as size of inputs, to the currently executing ML model algorithm size-variant. In embodiments herein, the ML model algorithm output confidence score may be affected by the user query input received, for example, where a vague user query input or a longer user query input may require a more robust ML model algorithm size-variant for execution of an operation step of the AI productivity tool software module 162 in identifying or executing a responsive capability intent action to a received user query input.

Thus, if the output from the execution of a specific, selected ML model algorithm 282, 284, 286 for an identified productivity-tool operation type (e.g., embedding an identified query intent value or matching to a capability intent value) is provided via output from the small variant of that specific, selected ML model algorithm is determined to not have a high enough ML model algorithm output confidence score to meet a threshold ML model algorithm output confidence score, an imprecise determined query intent value or an imprecise lexical or semantic similarity matching to a capability intent may be impactful to operations of the AI productivity tool software module 262 in an embodiment. In such an embodiment, the user-query input is again run through a relatively larger variant of a ML model algorithms 282, 284, 286 (e.g., a default ML model algorithm variant or a large ML model algorithm variant of the query intent determination or query intent-to-capability matching ML model algorithm) at that AI productivity tool software module process operation step in order to increase the confidence score for a more precise result in responding to a user query input. This may be done while also working within the constraints of the QoS metric thresholds such that a sufficient level of resources are consumed to minimize or not impact other hardware processing on the information handling system 200. In embodiments herein, the ML model algorithm output confidence of the output from the ML model algorithms 282, 284, 286 is monitored to remain sufficient for execution of identified productivity-tool operation for the AI productivity tool software module 262. In an embodiment, the switch between in-band, side-band, or networked ML model algorithm execution provider hardware processor and selected size-variants of the ML model algorithms 182, 184, 186 may be completed within a feedback loop process in order to achieve these goals described herein.

The systems and methods described herein provides for the identification, registration, and assessment of availability of any number of in-band, side-band, or networked ML model algorithm execution provider hardware processors for use in execution of an AI productivity tool software module 162. The selection among any given in-band, side-band, and networked ML model algorithm execution provider hardware processor is also based on current operating conditions of the information handling system such that QoS metric thresholds are met which would otherwise affect the operation of the information handling system to a degree that would be noticeable to the user. By also allowing the execution of the ML model algorithms 182, 184, 186 in their various size variants to be switch amongst themselves as well as from first in-band, side-band, or networked ML model algorithm execution provider hardware processor to a second in-band, side-band, or networked ML model algorithm execution provider hardware processor, the QoS metric thresholds are not exceeded and the user does not notice any reduction in processing within the information handling system 100 while maintaining sufficient ML model algorithm output confidence levels.

The systems and methods described herein provides for the identification, registration, and assessment of availability of any number of in-band, side-band, and networked ML model algorithm execution provider hardware processors for use in execution of an AI productivity tool software module 262. The selection of any given in-band, side-band, or networked ML model algorithm execution provider hardware processor is also based on current operating conditions of the information handling system such that QoS metric thresholds are met which would otherwise affect the operation of the information handling system to a degree that would be noticeable to the user. By also allowing the execution of the ML model algorithms 282, 284, 286 in their various size variants to be switch amongst themselves as well as from a first in-band, side-band, or networked ML model algorithm execution provider hardware processor to a second in-band, side-band, or networked ML model algorithm execution provider hardware processor, the QoS metric thresholds are not exceeded and the user does not notice any reduction in processing within the information handling system 200 while maintaining sufficient ML model algorithm output confidence levels.

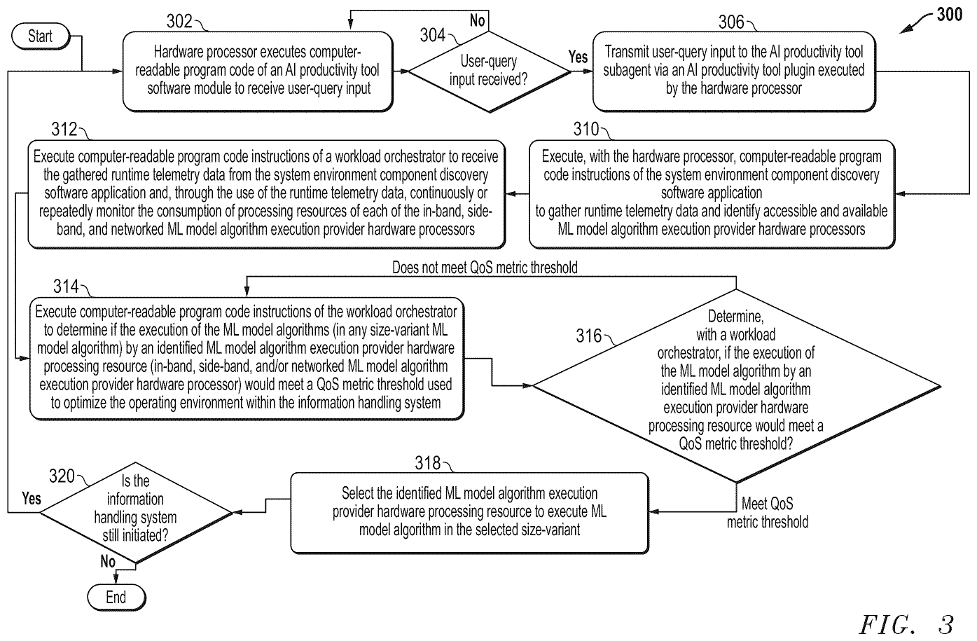

FIG. 3 is a flow diagram showing a method 300 of discovering and prioritizing available ML model algorithm execution provider hardware processors based on identified ML model algorithms to be invoked to identify and execute a capability intent action at an information handling system according to an embodiment of the present disclosure. The method 300 described in connection with FIG. 3 may be operated on an information handling system such as an information handling system (e.g., 100, 200) described in connection with FIG. 1 or 2. In an embodiment, the systems and methods described herein may operate on the information handling system such that the method is executed “on-the-box” such that a wired or wireless network connection to a network is not necessary for operation of the method. In another embodiment, some modules, databases, and/or hardware processing resources may be maintained on a remote server or at a side-band operatively coupled processing device via a wired or wireless network connection made with these remote servers or side-band operatively coupled processing devices according to the method implemented as described in embodiments herein.

The method 300 may include, at block 302, the hardware processor or other hardware processing device of the information handling system executing computer-readable program code instructions of an AI productivity tool software module to receive user-query input. In an embodiment, AI productivity tool software module may be any application that can receive input from a user such as text input via the keyboard, image or touch input via a touchpad, or speech input via the microphone, for example. In some embodiments, text or audio may be received by an interface of the one or more AI productivity tool-enablable software modules and the interface managed by the AI productivity tool sub-agent. In an embodiment, the AI productivity tool software module may include a virtual assistant-type AI software agent. In various embodiments, the hardware processor or other alternative hardware processing resources of the information handling system may execute computer-readable program code instructions of the AI productivity tool software module with its AI productivity tool software plug-in and monitor for user-query inputs at a microphone, keyboard, or other input device for the AI productivity tool subagent to engage in capability intent actions responsive to the user-query inputs.

Therefore, at block 304, the method 300 includes determining whether any user-query input has been received at the AI productivity tool software module. Where, at block 304, no user-query input is received, the method 300 returns to block 302 with the AI productivity tool software module continuing to monitor for this input. Where, at block 304, the AI productivity tool software module does detect and receive user-query input, the method 300 continues to block 306 with the user-query input being transmitted to an AI productivity tool subagent, via an AI productivity tool plugin being executed by the hardware processor of the information handling system. In an embodiment, the AI productivity tool subagent may provide AI productivity services as described herein.

In an embodiment, at block 306, the AI productivity tool subagent may be used to invoke one or more ML model algorithms, each or any having various size variants, in order to execute one or more productivity-tool operations to generate a query intent value, where applicable, and match to an appropriate capability intent value of an AI productivity tool-enablable software application that can perform the responsive capability intent action to a received user query input. For example, the ML model algorithms may include a speech-to-text model algorithm in order to, where necessary, convert any audio user-query input into text or other machine-readable program code instructions for further processing by the AI productivity tool subagent. In an embodiment, the speech-to-text model algorithm may include an automatic speech recognition ML model algorithm or other speech recognition ML model algorithm. In another embodiment, the ML model algorithms include a query input-to-intent ML model algorithm that receives the user-query input, and with an embedding algorithm generates a vectorized query intent value for the user-query input for later correlation with a capability intent value. In an embodiment, the ML model algorithms may also include a query intent-to-capability matching ML model algorithm that receives the vectorized query intent value as input and matches the vectorized query intent value to a vectorized capability intent value associated with one or more AI productivity tool-enablable software applications via a similarity correlation algorithm for lexical or semantic matching to identify a responsive capability that can execute a capability intent action responsive to a user-query input received at the AI productivity tool software module.

The identification of a capability associated with one or more AI productivity tool-enablable software application will cause the AI productivity tool subagent to signal the execution of one or more AI productivity tool-enablable software applications to change features, settings, or other actions on the information handling system for the user in response to the received user query input. It is appreciated that any of the ML model algorithms for any particular operational process step of the AI productivity tool software module may each include a “small,” “default,” and “large” variant that can be selected to be invoked based on anticipated and current consumption of hardware processing resources, other telemetry conditions of the information handling system, and ML model algorithm output confidence scoring levels in embodiments herein.

Proceeding to block 308, the method 300 may include the hardware processor or any other hardware processing device executing computer-readable program code instructions of a system environment component discovery software application to gather runtime telemetry data and identify accessible and available ML model algorithm execution provider hardware processors. The runtime telemetry data may, in some example embodiments, include data transfer rates between the AI productivity tool subagent and an ML model algorithm execution provider hardware processors executing in-band on-the-box as well as those accessible via side-band and networked connections. Other runtime telemetry data gathered may include available RAM at the information handling system, current processing resource consumption of each of the available in-band, side-band, or networked ML model algorithm execution provider hardware processors, processing capabilities of each of the available in-band, side-band, or networked ML model algorithm execution provider hardware processors, and supported runtime services that deploy execution of any given ML model algorithm across one or multiple in-band, side-band, or networked ML model algorithm execution provider hardware processors. It is appreciated that this and other types of telemetry data may be used to help determine which of the in-band, side-band, or networked ML model algorithm execution provider hardware processors can be used to execute the ML model algorithms described in embodiments herein. Further, this and other types of telemetry data may also be used to determine under what conditions the execution of any given ML model algorithm is completed on any given ML model algorithm execution provider hardware processor or switched to another ML model algorithm execution provider hardware processor in embodiments herein.

As mentioned, the execution of the computer-readable program code instructions of the system environment component discovery software application at block 310 also identifies available and accessible ML model algorithm execution provider hardware processors either via in-band, side-band, or network connections. In an example embodiment, the system environment component discovery software application may access one or more hardware drivers to detect the availability and accessibility of in-band ML model algorithm execution provider hardware processors within the information handling system. In another embodiment, the execution of the system environment component discovery software application may access a baseboard management controller executing a hardware management engine that is used to discover those side-band and networked ML model algorithm execution provider hardware processors that are made available via side-band or network wireless or wired communications to the information handling system. The baseboard management controller of system environment component discovery software application executes a hardware management engine may operate to ping a hardware management engine agent operating at a PAN connected hardware device 197, such as a docking station, or a networked remote server in an embodiment. Computer readable code instructions of hardware management engine agents at PAN connected hardware device, such as the docking station, or a networked remote server may report telemetry data for those side-band and networked ML model algorithm execution provider hardware processors that are made available via side-band or network wireless or wired communications to the information handling system in an embodiment. The present specification contemplates that any type of discovery method and system may be implemented herein to both discover each ML model algorithm execution provider hardware processor, determine if those ML model algorithm execution provider hardware processors are accessible to the information handling system, and further determine if those ML model algorithm execution provider hardware processors are available (e.g., processing resources available) for execution of the ML model algorithms described herein.

In an embodiment, the computer-readable program code instructions of the hardware drivers or the baseboard management controller executing a hardware management engine may also be used by the system environment component discovery software application to identify the existence of one or more of the in-band, side-band, or networked ML model algorithm execution provider hardware processors. The baseboard management controller executing a hardware management engine may operate to ping a hardware management engine agent operating at a PAN connected hardware device, such as a docking station, or a networked remote server in an embodiment. Computer readable code instructions of hardware management engine agents at PAN connected hardware device, such as a docking station, or a networked remote server may report telemetry data for those side-band and networked ML model algorithm execution provider hardware processors that are made available via side-band or network wireless or wired communications to the information handling system in an embodiment. Further, the wireless interface adapter or a wired network interface device may determine telemetry data such as wireless signal conditions (received signal strength, signal to noise, or other), connection latency, connection data bandwidth/congestion or throughput, among other wired or wireless link connection telemetry data in embodiments herein.

Additionally, the hardware drivers or remotely executing hardware management engine agents may also identify any telemetry data associated with the operation of the ML model algorithm execution provider hardware processing resources such as current consumption of processing resources (for example, peta operations per second (pTops), exa operations per second (cTops), current workloads and usage metrics), RAM occupancy, latency of execution, and other metrics. In some embodiments, additional telemetry data may include individual application usage of ML model algorithms and system resources, thermal effects on, for example, the battery or processor operation, latencies depending on the location of the ML model algorithms in the topology of the information handling system, and E3 data for carbon impacts by the operations of the information handling system. It is appreciated that any other runtime telemetry data may be retrieved while any of the ML models are executed or are about to be executed and may be stored for future execution of similar ML model algorithms to anticipate telemetry data changes for selection among available size-variants of an ML model algorithm for a common identified productivity-tool operation. It is also appreciated that any runtime telemetry data may be retrieved using any hardware drivers or the hardware management engine agents and may include, for example, a hardware driver associated with the PMU that provides battery RSOC data (e.g. a range of 0% to 100%). It is appreciated that any other telemetry data may be acquired by the system state component discovery software application via the hardware drivers or the hardware management engine agents that would provide additional information related to resource consumptions at the information handling system as the ML model algorithm size variants are being executed by a ML model algorithm execution provider hardware processing resource.

In a specific example embodiment, a hardware processing device may execute computer-readable program code instructions of a Dell® Telemetry Manager®. The execution of the computer-readable program code instructions of the Dell® Telemetry Manager® may automatically cause this telemetry data to be retrieved and sent to the system environment component discovery software application for processing and use in determining, by the workload orchestrator, whether a pending execution by an in-band, side-band, or networked ML model algorithm execution provider hardware processor and a selection among a plurality of available size-variant ML model algorithms is appropriate for the current operating conditions detected in the telemetry data gathered by execution of the system environment component discovery software application.

At block 310, the method 300 includes the hardware processing device executing computer-readable program code instructions of the workload orchestrator to initially receive the gathered runtime telemetry data from the system environment component discovery software application. In an embodiment, the execution of the computer-readable program code instructions of the workload orchestrator may also, through the use of the runtime telemetry data, continuously or repeatedly monitor the consumption of processing resources or other QoS metrics of the information handling system and each of the available in-band, side-band, or networked ML model algorithm execution provider hardware processors.

At block 312, the method 300 also includes the execution of the computer-readable program code of the workload orchestrator to determine if the execution of the ML model algorithms (in any size-variant ML model algorithm) by an identified ML model algorithm execution provider hardware processing resource (in-band, side-band, and/or networked ML model algorithm execution provider hardware processor) would meet a QoS metric threshold used to ensure no degradation of the operating environment within the information handling system for process operations of the AI productivity tool software module in identifying and execution responsive capabilities to user query inputs as well as execution of other software processes. Indeed, where the processing resource consumption at some ML model algorithm execution provider hardware processor exceeds a QoS metric threshold for example, the workload orchestrator may determine that that ML model algorithm execution provider hardware processor is not available to execute a ML model algorithm, in any size-variant ML model algorithm, as described herein.

As described herein, the workload orchestrator, after receiving the runtime telemetry data from the system environment component discovery software application that includes descriptions of the individual in-band, side-band, or networked ML model algorithm execution provider hardware processors made available to the information handling system, may also determine, for each, which of those in-band, side-band, or networked ML model algorithm execution provider hardware processors are better configured to execute the type of ML model algorithms needed for execution of one or more process operation steps of the AI productivity tool software module to identify and execute responsive capability intent action for a user query input. It is appreciated that the execution of some of the ML model algorithms may be better fit for some types of ML model algorithm execution provider hardware processors such as NPUs, for example, as described in embodiments herein. Although other hardware processors (CPUs, ECs, GPUs, NPUs) may be used to execute these ML model algorithms in order to identify a capability associated with any AI productivity tool-enablable software application, certain hardware processors selected from a plurality of potentially available ML model algorithm execution provider hardware processors are identified as being better suited for execution of particular types of ML model algorithms. For example, NPUs in particular are specialized hardware processing devices that are designed to accelerate AI and ML applications and execute ML model algorithms. As such, the workload orchestrator may set a preference to execute the ML model algorithms on corresponding hardware processing resources that may be suited to the type and size or breadth of a particular ML model algorithm being invoked. For example, a small sized, low-processing ML model requirement may be executed on an embedded controller or an APU to avoid saturation of a CPU or NPU. In another example embodiment, NPUs made available to and detected by the information handling system via the system environment component discovery software application based on suitability of NPUs for types of ML model algorithms set to be invoked.

Still further, the workload orchestrator may monitor currently-executing ML model algorithms on each of the in-band, side-band, or networked ML model algorithm execution provider hardware processors. For example, a CPU, side-band NPU, or networked NPU may have been tasked with executing the speech-to-text ML model algorithm in order to convert the audio input from the microphone into text or other computer-readable language so that that text may be later interpreted by other ML model algorithms such as the query input-to-intent ML model algorithm. Other ML model algorithms may also concurrently be executed on the in-band NPU such as the query input-to-intent ML model algorithm and query intent-to-capability matching ML model algorithm. The in-band NPU may be executing these ML model algorithms because these ML model algorithms may require higher processing resources to execute them and the in-band NPU is designed to execute these types of AI and ML model algorithms. Thus, in this example, the CPU of the information handling system, rather than a side-band NPU, or networked NPU, may be selected where hardware processing resource requirements are light and the QoS metric threshold for that CPU is not exceeded or otherwise not met. In other embodiments, side-band NPU and networked NPU may be selected, in some embodiments, where data transmission rates are not a concern and the latency of transmission between the side-band NPU and/or networked NPU and the information handling system is not a concern but the in-band CPU is reaching a QoS metric threshold.

It is appreciated that, during regular use of the information handling system by the user, other computer-readable program code instructions may be executed on the hardware processor (e.g., CPU) such as background software applications and foreground software applications. The execution of these software applications may consume significant processing resources at the CPU (e.g., a foreground gaming application and/or a background antivirus/antimalware application). The runtime telemetry data received by the workload orchestrator includes data indicating that the CPU is a current ML model algorithm executing ML model algorithm execution provider hardware processor, but that current processing consumption data of the CPU currently exceeds the QoS metric threshold. In this instance, the workload orchestrator will not select the CPU to execute the ML model algorithm executions. Instead, because the information handling system may include an in-band NPU, the workload orchestrator may use the NPU as the ML model algorithm executing ML model algorithm execution provider hardware processor along with the option to extend or share the execution of the ML model algorithms to any other in-band, side band, or networked ML model algorithm execution provider hardware processor. Thus, the workload orchestrator may aggregate the runtime telemetry data, discover current processing resource consumption metrics at each of the available in-band, side-band, or networked ML model algorithm execution provider hardware processors, and assign the execution of the ML model algorithms to those ML model algorithm execution provider hardware processors that have not exceeded one or more QoS metric thresholds. In one embodiment, the QoS metric threshold may be set as a percentage of processing resources consumed at each of the individual available ML model algorithm execution provider hardware processors. In other embodiments, the QoS metric threshold may be set as maximum processing and communication latency from each of the individual available ML model algorithm execution provider hardware processors. In other embodiments, the QoS metric threshold may be set as limits on RAM utilization, power consumption, heat levels, communication link limitations or other telemetry of embodiments herein as related to each of the available ML model algorithm execution provider hardware processors.

At block 314, the method 300 includes determining if the execution of the ML model algorithm by an identified ML model algorithm execution provider hardware processing resource would meet a QoS metric threshold. Where the execution of the ML model algorithm by an identified ML model algorithm execution provider hardware processing resource would not meet a QoS metric threshold, the method 300 returns back to block 312 to select a different size variant of a ML model algorithm and/or select a different ML model algorithm execution provider hardware processor. Where the execution of the ML model algorithm by an identified ML model algorithm execution provider hardware processing resource would meet a QoS metric threshold described herein, the method 300 continues to block 316. At block 316, the method 300 includes selecting the identified ML model algorithm execution provider hardware processing resource to execute the identified ML model algorithm in the selected size-variant.

At block 318, the method 300 includes determining if the information handling system is still initiated. Where the information handling system is still initiated, the method 300 proceeds to block 302 as described herein. Where the information handling system is no longer initiated, the method 300 may end here.

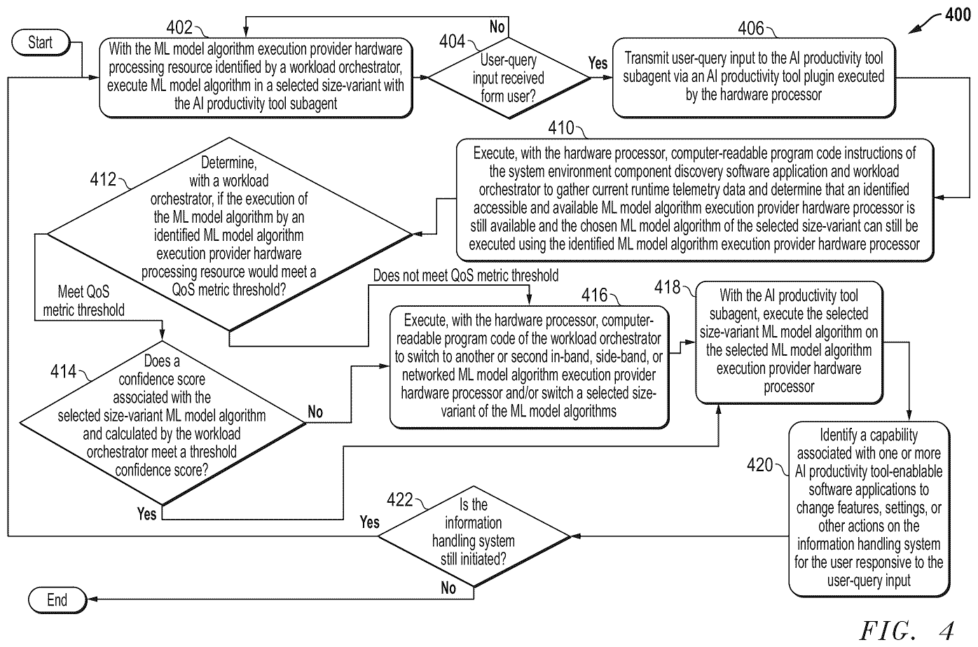

FIG. 4 is a flow diagram showing a method 400 of detecting user-query input and using determined ML model algorithms to be invoked in order to identify a capability associated with one or more AI productivity tool-enablable software applications via selection of one or more available hardware processing resources and size variants of ML model algorithms according to an embodiment of the present disclosure. Similar to FIG. 3, the method of FIG. 4 may be executed on an information handling system similar to the information handling systems described in FIGS. 1 and 2. In an embodiment, the systems and methods described herein may operate on the information handling system such that the method is executed “on-the-box” such that a wired or wireless network connection to a network is not necessary for operation of the method. In another embodiment, some modules, databases, and/or processing resources may be maintained on a remote server or at a PAN-connected device using a wired or wireless network connection can be made with these remote servers or PAN-connected device according to the method implemented as described in embodiments herein.

In an embodiment, the method 400 may include, at block 402, the hardware processor or other hardware processing device of the information handling system executing computer-readable program code instructions of an AI productivity tool software module to receive user-query input. In an embodiment, AI productivity tool software module may be any application that can receive input from a user such as text input via the keyboard, image or touch input via a touchpad, or speech input via the microphone, for example. In some embodiments, text or audio may be received by an interface of the one or more AI productivity tool-enablable software modules and the interface managed by the AI productivity tool sub-agent. In an embodiment, the AI productivity tool software module may include a virtual assistant-type AI software agent. In various embodiments, the hardware processor or other alternative hardware processing resources of the information handling system may execute computer-readable program code instructions of the AI productivity tool software module with its AI productivity tool software plug-in and monitor for user-query inputs at a microphone, keyboard, or other input device for the AI productivity tool subagent to engage in capability intent actions responsive to the user-query inputs.

Therefore, at block 404, the method 400 includes determining whether any user-query input has been received at the AI productivity tool software module. Where, at block 404, no user-query input is received, the method 400 returns to block 402 with the AI productivity tool software module continuing to monitor for this input. Where, at block 404, the AI productivity tool software module does detect and receive user-query input, the method 400 continues to block 406 with the user-query input being transmitted to an AI productivity tool subagent, via an AI productivity tool plugin being executed by the hardware processor of the information handling system. In an embodiment, the AI productivity tool subagent may provide AI productivity services as described herein.

At block 408, the method 400 may take advantage of the method described in FIG. 3, with the execution of the system environment component discovery software application and the workload orchestrator as described in embodiments herein. In an embodiment, the computer-readable program code instructions of the system environment component discovery software application and workload orchestrator may be executed by a hardware processor to gather current runtime telemetry data and determine that the identified accessible and available ML model algorithm execution provider hardware processor (e.g., identified at block 316 of FIG. 3) is still available and the chosen ML model algorithm in the selected size-variant can still be executed using the identified ML model algorithm execution provider hardware processor. As described herein, the execution of the computer-readable program code instructions of the workload orchestrator may continuously or repeatedly monitor the consumption of processing resources of each of the in-band, side-band, or networked ML model algorithm execution provider hardware processors through the use of the runtime telemetry data received from the system environment component discovery software application in embodiments herein. Because hardware processing resources associated with the identified accessible and available ML model algorithm execution provider hardware processor (e.g., identified at block 316 of FIG. 3) as well as each of the available in-band, side-band, or networked ML model algorithm execution provider hardware processors may change over time, the workload orchestrator may receive the runtime telemetry data from the system environment component discovery software application that continuously updates the status of each of the ML model algorithm execution provider hardware processors being currently used for execution as well as those made available and accessible to the information handling system.

Additionally, because the processing resources of each of the ML model algorithm execution provider hardware processors may change over time, the selected size-variant of available ML model algorithms may also change such that the QoS metric threshold is not exceeded, but a sufficient level of an ML model algorithm output confidence score is maintained for precision of execution of the operation steps of the AI productivity tool software module. Again, the QoS metrics threshold may be set to and include a specific level of consumption ML model algorithm execution provider ML model algorithm execution provider hardware processor (e.g., >eTops/second) or RAM occupancy above which some or all processes executing on the information handling system, including those of AI productivity-tool operations, will be negatively impacted such that the impact may be noticed by a user. In another embodiment, the QoS metrics threshold may be set to maximum processing and communication latency, or a specific maximum level of power consumption (e.g., >40 W/hour) relative to ongoing available battery power.

Therefore, at block 410, the method 400 includes determining if the execution of the selected size-variant ML model algorithm by an identified ML model algorithm execution provider hardware processing resource would meet a QoS metric threshold. Where the execution of the selected size-variant ML model algorithm by the identified ML model algorithm execution provider hardware processing resource would not meet a QoS metric threshold, the method 400 continues to block 414. At block 414, the hardware processor may execute computer-readable program code of the workload orchestrator to switch to a second in-band, side-band, or networked ML model algorithm execution provider hardware processor and/or select a different selected size-variant of the ML model algorithm being invoked by the AI productivity tool software module. Again, the selection of the ML model algorithm execution provider hardware processor and selected size-variant of available ML model algorithm is based on the current runtime telemetry data gathered by the system environment component discovery software application and provide to the workload orchestrator. With the identification of a new ML model algorithm execution provider hardware processor and/or size-variant of available ML model algorithm, the method 400 may continue to block 416.

Returning to block 410, where the execution of the ML model algorithm by an identified ML model algorithm execution provider hardware processing resource would meet a QoS metric threshold, the method 400 continues to block 412. At block 412, the method 400 also includes determining if an ML model algorithm output confidence score associated with the available size-variant ML model algorithms, as calculated by the workload orchestrator based on the user query input, size of inputs, or other factors, meets an ML model algorithm output threshold confidence score in an embodiment. The ML model algorithm output threshold confidence score is to ensure a minimum level of precision at this particular operational step executed by the ML model algorithm of the AI productivity tool software module executing to identify and execute a responsive capability intent action to a user query input.

In an embodiment, the workload orchestrator may engage in an ML model algorithm output confidence scoring process that calculates an ML model algorithm output confidence score related to the selection of the execution of any given ML model algorithms and/or variant of any given ML model algorithm by any selected in-band, side-band, or networked ML model algorithm execution provider hardware processor. This ML model algorithm output confidence score relates to the precision in executing the identified productivity-tool operation type common to the grouped plurality of available size-variants of the ML model algorithms for a process operation step of the execution of the AI productivity tool module. In an embodiment, the ML model algorithm output confidence score may be provided during the execution of the ML model algorithms (e.g., variants of the ML model algorithms) based on the probabilities used to identify each output class during the execution of the ML model algorithm. For example, the statistical correlation between various inputs and a selected output or outputs that the ML model algorithm is predicting may serve as the ML model algorithm output confidence score. It may be affected by the size or number of input parameters, and may even be affected by the user query input itself in embodiments herein. For example, vagueness or size of the user query input may require additional recursive processing runs of an ML model algorithm as well as the number of input parameters needed. Thus, in those embodiments where the ML model algorithms are probabilistic, the output probability is used as the ML model algorithm output confidence score described herein.

In an example embodiment, a similarity search (e.g., a semantic search) may serve as the confidence score with the score being 1-cosine_distance (user_input, known_intent) where the cosine_distance is between 0 and 1 such that the more confident values are close to 0. The level of statistical correlation between query intent and a capability intent may be the ML model algorithm output confidence score. Thus, a maximum score over all known_intent values is the overall score used to decide the ML model algorithm output confidence score in some embodiments. Thus, the output from the execution of a specific, selected ML model algorithm for an identified productivity-tool operation type (e.g., embedding an identified query intent value or matching to a capability intent value provided via output from the small variant of the query input-to-intent ML model algorithm) may not have a high ML model algorithm output confidence score to meet a threshold ML model algorithm output confidence score such that an imprecise determined query intent value or an imprecise lexical or semantic similarity matching to a capability intent may occur and be impactful to operations of the AI productivity tool software module. In such an embodiment, the user-query input is again run through a relatively larger variant of a ML model algorithm (e.g., a default ML model algorithm variant or a large ML model algorithm variant of the query intent determination or query intent-to-capability matching ML model algorithm) as described at block 414 in order to increase the ML model algorithm output confidence score for a more precise result in responding to a user query input. In an embodiment, where a relatively larger variant of ML model algorithm is necessary, the workload orchestrator may be provided with that data for the workload orchestrator to review which, if any, available in-band, side-band, or networked ML model algorithm execution provider hardware processors is more available and suitable to execute those relatively larger size variants of ML model algorithms. Where the calculated ML model algorithm output confidence score does meet the threshold confidence score, the method 400 may continue to block 416.

At block 416, the method 400 continues with the AI productivity tool subagent executing the selected size-variant ML model algorithm on the selected ML model algorithm execution provider hardware processor. As such, during operation, the AI productivity tool subagent may execute a speech-to-text ML model algorithm, in order to, where necessary, convert any audio user-query input into text or other machine-readable program code instructions for further processing by the AI productivity tool subagent. In an embodiment, the AI productivity tool subagent may execute a query input-to-intent ML model algorithm that receives the user-query input and with an embedding algorithm generates a vectorized query intent value for the user-query input for later correlation with a capability intent value. In an embodiment, the AI productivity tool subagent may execute a query intent-to-capability matching ML model algorithm that receives the vectorized query intent value as input and matches the vectorized query intent value to a vectorized capability intent value associated with one or more AI productivity tool-enablable software applications. The query intent-to-capability matching ML model algorithm executes a similarity correlation algorithm for lexical or semantic matching to identify a responsive capability that can execute a capability intent action responsive to a user-query input received at the AI productivity tool software module. Again, each of these ML model algorithms may each include a “small.” “default,” and “large” size-variant that will provide differently accurate and precise outputs but that have been selected by the workload orchestrator to satisfy the QoS metrics described herein. Additionally, each of the selected size-variant of available ML model algorithms may be executed on a single selected ML model algorithm execution provider hardware processor or may be distributed among a plurality of in-band, side-band, and networked ML model algorithm execution provider hardware processors identified as accessible and available to the information handling system.

At block 418, the method 400 includes identifying a capability associated with one or more AI productivity tool-enablable software applications to change features, settings, or other capability intent actions on the information handling system for the user based on the user-query input. This capability is responsive to the user-query input originally presented to the information handling system by the user. With these changed features, settings, or other capability intent actions being carried out, the systems and methods described herein have provided for the identification, registration, and assessment of availability of any number of in-band, side-band, or networked ML model algorithm execution provider hardware processors for use in execution of an AI productivity tool software module. The selection of any given in-band, side-band, or networked ML model algorithm execution provider hardware processor is also based on current operating conditions of the information handling system such that QoS metric thresholds are not exceeded, or otherwise not met, do not affect the operation of the information handling system to a degree that would be noticeable to the user. By also allowing the execution of the ML model algorithms in their various size variants to be switch amongst themselves as well as from a first in-band, side-band, or networked ML model algorithm execution provider hardware processor to a second in-band, side-band, or networked ML model algorithm execution provider hardware processor, the QoS metric thresholds are not exceeded and the user does not notice any reduction in processing within the information handling system

At block 420, the method 400 includes determining if the information handling system is still initiated. Where the information handling system is still initiated, the method 400 proceeds to block 402 as described herein. Where the information handling system is no longer initiated, the method 400 may end here.

The blocks of the flow diagrams of FIGS. 3 and 4 or steps and aspects of the operation of the embodiments herein and discussed herein need not be performed in any given or specified order. It is contemplated that additional blocks, steps, or functions may be added, some blocks, steps or functions may not be performed, blocks, steps, or functions may occur contemporaneously, and blocks, steps, or functions from one flow diagram may be performed within another flow diagram.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The subject matter described herein is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents and shall not be restricted or limited by the foregoing detailed description.

What is claimed is:

1. An information handling system executing computer-readable program code instructions of an artificial intelligence (AI) productivity tool software module comprising:
a first machine learning (ML) model algorithm execution provider hardware processor and a random-access memory (RAM);
the first ML model algorithm execution provider hardware processor executing computer-readable program code instructions of the AI productivity tool software module to invoke a plurality of ML model algorithms to execute operational processing steps to identify and execute a responsive capability intent action based on user-query input received at the AI productivity tool software module;
the first ML model algorithm execution provider hardware processor executing computer-readable program code instructions of a system environment component discovery software application to gather runtime telemetry data describing accessibility to and current processing consumption state of a plurality of available in-band ML model algorithm execution provider hardware processors, and available side-band and networked ML model algorithm execution provider hardware processors operatively coupled to the information handling system;
the first ML model algorithm execution provider hardware processor executing computer-readable program code instructions of a workload orchestrator to determine a second ML model algorithm execution provider hardware processor from the plurality of available in-band, side-band, and networked ML model algorithm execution provider hardware processors is within a quality of service (QoS) metric threshold for processing activity; and
the first ML model algorithm execution provider hardware processor to switch to a second ML model algorithm execution provider hardware processor of the plurality of available in-band, side-band, and networked ML model algorithm execution provider hardware processors to execute at least one ML model algorithm of the plurality of ML model algorithms to execute an operational step of the AI productivity tool software module when the first ML model algorithm execution provider hardware processor exceeds the QoS metric threshold.

2. The information handling system of claim 1, wherein the second ML model algorithm execution provider hardware processor is a side-band ML model algorithm execution provider hardware processor operating within a peripheral device operatively coupled to the information handling system via a personal area network (PAN) link with the information handling system.

3. The information handling system of claim 1, wherein the second ML model algorithm execution provider hardware processor is a networked ML model algorithm execution provider hardware processor operating within a remote server system operatively coupled to the information handling system via network and a wireless link with the information handling system.

4. The information handling system of claim 1 further comprising:
the hardware processor executing computer-readable program code instructions of the AI productivity tool software module to invoke a first size-variant ML model algorithm selected from a plurality of available size-variant ML model algorithms for the at least one ML model algorithm to identify the responsive capability intent action based on the user query input received at the AI productivity tool software module, wherein the plurality of available size-variant ML model algorithms for the at least one ML model algorithm includes disparate number of input parameters accepted and processing bit sizes determining the size of each of the plurality of available size-variant ML model algorithms.

5. The information handling system of claim 2, wherein when the workload orchestrator determines that the execution of the first size-variant ML model algorithm by a first ML model algorithm execution provider hardware processor exceeds the QoS metric threshold, the workload orchestrator switches the first size-variant ML model algorithm selected to be executed on the first ML model algorithm execution provider hardware processor to a second size-variant ML model algorithm for the at least one ML model algorithm.

6. The information handling system of claim 1 further comprising:
the hardware processor executing computer readable program code of the workload orchestrator to determine a ML model algorithm output confidence score associated with the execution of a first size-variant ML model algorithm of the at least one ML model algorithm via the first ML model algorithm execution provider hardware processor, and when the ML model algorithm output confidence score does not meet a threshold ML model algorithm output confidence score, the workload orchestrator switches to a second size-variant ML model algorithm for the at least one ML model algorithm to identify or execute the responsive capability intent action to the user-query input.

7. The information handling system of claim 6, wherein the hardware processor executes the computer readable program code of the workload orchestrator to iteratively determine the ML model algorithm output confidence score associated with the execution of each of a plurality of subsequently-selected size-variant ML model algorithms for the at least one ML model algorithm until the threshold confidence score is met.

8. The information handling system of claim 1 further comprising:
the runtime telemetry data includes data transfer rates between the first ML model algorithm execution provider hardware processor and the AI productivity tool software module, available RAM at the information handling system, processing capabilities of each of the available ML model algorithm execution provider hardware processors, and enumeration of supported runtime services that deploy execution of at least one of the plurality of ML model algorithms across one or multiple available ML model algorithm execution provider hardware processors.

9. A method of discovering and prioritizing available ML model algorithm execution provider hardware processors in an information handling system executing an artificial intelligence (AI) productivity tool software module comprising:
executing computer-readable program code instructions of the AI productivity tool software module, via first ML model algorithm execution provider hardware processor, to invoke a plurality of ML model algorithms to execute operational processing steps to identify and execute a responsive capability intent action based on user-query input received at the AI productivity tool software module;
executing computer-readable program code instructions of a system environment component discovery software application to gather runtime telemetry data describing current processing consumption state of a plurality of available in-band ML model algorithm execution provider hardware processors, and available side-band and networked ML model algorithm execution provider hardware processors operatively coupled to the information handling system;
executing computer-readable program code instructions of a workload orchestrator to determine a second ML model algorithm execution provider hardware processor from the plurality of available in-band, side-band, and networked ML model algorithm execution provider hardware processors is within a quality of service (QoS) metric threshold for processing activity; and
switching, via the workload orchestrator, to a second ML model algorithm execution provider hardware processor of the plurality of available in-band, side-band, and networked ML model algorithm execution provider hardware processors to execute a first ML model algorithms to execute an operational step of the AI productivity tool software module when the first ML model algorithm execution provider hardware processor does not meet the QoS metric threshold.

10. The method of claim 9, wherein the second ML model algorithm execution provider hardware processor is another in-band ML model algorithm execution provider hardware processor on-the-box of the information handling system.

11. The method of claim 9, wherein the second ML model algorithm execution provider hardware processor is a side-band ML model algorithm execution provider hardware processor operating within a peripheral device operatively coupled to the information handling system via a personal area network (PAN) link with the information handling system.

12. The method of claim 9, wherein the second ML model algorithm execution provider hardware processor is a networked ML model algorithm execution provider hardware processor operating within a remote server system operatively coupled to the information handling system via network and a wireless link with the information handling system.

13. An information handling system executing computer-readable program code instructions of an artificial intelligence (AI) productivity tool software module comprising:
a first machine learning (ML) model algorithm execution provider hardware processor and a random-access memory (RAM);
the first ML model algorithm execution provider hardware processor executing computer-readable program code instructions of the AI productivity tool software module to invoke a plurality of ML model algorithms execute operational processing steps to identify and execute a responsive capability intent action based on user-query input received at the AI productivity tool software module;
the first ML model algorithm execution provider hardware processor executing computer-readable program code instructions of a system environment component discovery software application to gather runtime telemetry data describing current processing consumption state of a plurality of available in-band ML model algorithm execution provider hardware processors, and available side-band and networked ML model algorithm execution provider hardware processors operatively coupled to the information handling system and suitability of types of available in-band, side-band, and networked ML model algorithm execution provider hardware processors to execute a first ML model algorithm type having an available plurality of size-variant ML model algorithms;
the first ML model algorithm execution provider hardware processor executing computer-readable program code instructions of a workload orchestrator to determine a second ML model algorithm execution provider hardware processor from the plurality of available in-band, side-band, and networked ML model algorithm execution provider hardware processors is within a quality of service (QoS) metric threshold for processing activity; and
the first ML model algorithm execution provider hardware processor to switch to a second ML model algorithm execution provider hardware processor of the plurality of available in-band, side-band, and networked ML model algorithm execution provider hardware processors that is suitable to execute the first ML model algorithm type to execute an operational step of the AI productivity tool software module when the first ML model algorithm execution provider hardware processor exceeds the QoS metric threshold.

14. The information handling system of claim 13, wherein the second ML model algorithm execution provider hardware processor is another in-band ML model algorithm execution provider hardware processor on-the-box of the information handling system.

15. The information handling system of claim 13, wherein the second ML model algorithm execution provider hardware processor is a side-band ML model algorithm execution provider hardware processor operating within a peripheral device operatively coupled to the information handling system via a personal area network (PAN) link with the information handling system.

16. The information handling system of claim 13, wherein the second ML model algorithm execution provider hardware processor is a networked ML model algorithm execution provider hardware processor operating within a remote server system operatively coupled to the information handling system via network and a wireless link with the information handling system.

17. The information handling system of claim 13, wherein the plurality of available size-variant ML model algorithms for the first ML model algorithm type includes disparate number of input parameters accepted and processing bit sizes determining the size of each of the plurality of available size-variant ML model algorithms.

18. The information handling system of claim 13, wherein when the workload orchestrator determines that the execution of the first size-variant ML model algorithm of the first ML model algorithm type by a first ML model algorithm execution provider hardware processor exceeds the QoS metric threshold, the workload orchestrator switches the first size-variant ML model algorithm to a second size-variant ML model algorithm for the first ML model algorithm type.

19. The information handling system of claim 13 further comprising:
the hardware processor executing computer readable program code of the workload orchestrator to determine a ML model algorithm output confidence score associated with the execution of a first size-variant ML model algorithm of the first ML model algorithm type via the first ML model algorithm execution provider hardware processor, and when the ML model algorithm output confidence score does not meet a threshold ML model algorithm output confidence score, the workload orchestrator switches to a second size-variant ML model algorithm for the first ML model algorithm type to identify or execute the responsive capability intent action to the user-query input.

20. The information handling system of claim 19, wherein the hardware processor executes the computer readable program code of the workload orchestrator to iteratively determine the ML model algorithm output confidence score associated with the execution of each of a plurality of subsequently-selected size-variant ML model algorithms for the first ML model algorithm type until the threshold confidence score is met.
